(19) United States
(12) Patent Application Publication
(10) Pub. No.: US 2024/0392455 A1
(43) Pub. Date: Nov. 28, 2024

(54) FRAME FOR ELECTROCHEMICAL CELLS AND STACK-TYPE DEVICES

(71) Applicant: IGAS ENERGY GMBH, Stolberg (DE)

(72) Inventors: Karl-Heinz Lentz, Stolberg (DE); Elena Borgardt, Stolberg (DE)

(21) Appl. No.: 18/701,406

(22) PCT Filed: Oct. 12, 2022
(86) PCT No.: PCT/EP2022/078416

§ 371 Date: Apr. 15, 2024

(30) Foreign Application Priority Data
Oct. 14, 2021 (EP) 21202604.1
Mar. 17, 2022 (EP) 22162625.2
Mar. 17, 2022 (EP) 22162709.4
Apr. 27, 2022 (EP) 22170349.9

(51) Int. Cl. C25B 13/02; C25B 9/05; C25B 9/21; C25B 9/63; C25B 9/67; C25B 9/77; C25B 13/04; C25B 15/08

(52) U.S. Cl. CPC C25B 13/02; C25B 9/05; C25B 9/21; C25B 9/63; C25B 9/67; C25B 9/77; C25B 13/04; C25B 15/08

(57) ABSTRACT

The invention relates to a novel frame for an electrochemical cell and for a stack-type device. The invention relates to the frame, electrochemical cells, preassembled modules, and stack-type device, which comprise the frame according to the invention, and to methods for producing the preassembled modules, electrochemical cells and stack-type devices which comprise the frame according to the invention. The frame according to the invention, the electrochemical cells and stack-type devices are suitable for the conversion or generation of gases and liquids under pressure. The invention is based on a novel frame and seal concept. The invention furthermore relates to a cover for a stack-type device.

The invention relates to frames for electrochemical cells and stack type devices for the electrochemical conversion or generation of gases and liquids under pressure. The invention relates to a new frame for electrochemical cells, stack-type devices and pre-assembled modules comprising the frame according to the invention, methods for manufacturing the pre-assembled modules and methods for manufacturing the stack-type devices. The frame according to the invention, the electrochemical cell according to the invention and the stack-type device according to the invention are suitable for the electrochemical conversion or generation of gases and liquids under pressure, e.g. electrolysis cells, fuel cells or cells for electrochemical compression. The invention is based on a new frame and seal concept. The invention also relates to a lid for a stack-type device.

Electrochemical cells are able to generate electricity by converting substances or to form other substances by applying electricity. The electrochemical cells have at least two electrodes, which act as electron conductors, and an electrolyte, which acts as an ion conductor. The preferred electrolyte for the cell developed here is a solid electrolyte, e.g. an ion-conducting membrane.

A classic electrochemical cell with a solid electrolyte consists of an ion-conducting membrane, which can be coated with a catalyst and where the reaction takes place. On the anode and cathode side, porous electrodes (anode and cathode) transport the gas or liquid towards or away from the electrolyte. The inflow or outflow of gas and liquids under pressure can be ensured by a frame made of conventional metal or high-strength plastic (PEEK). The electrodes (anode or cathode) are inserted into this frame. The frame is sealed laterally by O-rings or other seals such as flat gaskets or injected seals to prevent the gas or liquid from escaping from the electrochemical cell. To increase the product, the electrochemical cells can be connected in series to form a cell stack. The respective electrochemical cells are then separated from each other by a so-called bipolar plate. Devices comprising this arrangement are referred to as stack type devices 23.

Electrochemical cells and stack type devices comprising frames are known in the prior art.

EP 3 699 323 A1 relates to the supply of electrodes of an electrode stack, for example of an electrolyzer.

DE 25 33 728 A1 relates to an electrolytic cell with bipolar electrodes arranged side by side and an outer frame enclosing at least one chamber of the electrolytic cell.

EP 3 770 303 A1 relates to an electrode packing unit for a stack structure of an electrochemical reactor with a bipolar plate, two electrode plates and two current transfer structures arranged between the bipolar plate and the electrode plates.

Difficulties that typically occur when operating a classic electrochemical cell under pressure are:
1. Leak tightness problems because in a cell stack, i.e. a stack type device, the frames of many electrochemical cells are stacked on top of each other and each material used in the frames and other components has manufacturing tolerances. This can result in insufficient contact pressure for the O-rings or other seals used in some parts of the frame. Especially when the gases or liquids are under pressure, it is difficult or impossible to achieve tightness with the known seals.
2. The mechanical stability of the frame: when gases and liquids are converted or generated under pressure, the plastic frames are deformed (FIG. 2).
3. A small gap 17 remains between the electrode and frame 1. Into this gap 17 the solid-state electrolyte, for example membrane 13, is pressed during differential pressure operation. The solid-state electrolyte, for example membrane 13, is pressed or crawls 24 into the gap 17. This effect is intensified if the frame 1 is deformed due to low mechanical stability (see point 2), so that the gap 17 becomes larger (FIG. 2).
4. The frame often includes channels for the supply and removal of liquids and gas. In the state of the art, it is known to mill the channels out of the frame, i.e. out of the metal or plastic part, which results in high costs.

In order to be able to generate gases or liquids under high pressure for industrial purposes by means of electrochemical cells or to be able to introduce gases or liquids under high pressure into the electrochemical cells, an improved electrochemical cell is required which can be operated under high pressure and which does not have the disadvantages mentioned above.

The problem is solved by the invention according to claims 1 to 21.

An object of the invention is a frame 1 for an electrochemical cell 2 for a stack type device 23, the frame 1 comprising a first side of the frame 4 having a planar first surface and a second side of the frame 5 opposite the first side of the frame 4 having a planar second surface and an anode frame 8 and a cathode frame 11, and

wherein the anode frame comprises the first side of the frame 4, a side opposite the first side of the frame 4 of the anode frame 4″ and a first opening 6 for receiving the anode 7, wherein the first opening 6 extends from the first side of the frame 4 to the side opposite the first side of the frame 4 of the anode frame 4″,

wherein the cathode frame 11 comprises the second side of the frame 5, a side opposite the second side of the frame 5 of the cathode frame 5″ and a second opening 9 for receiving the cathode 10, wherein the second opening 9 extends from the second side of the frame 5 to the side opposite the second side of the frame 5 of the cathode frame 5″, wherein the side opposite the first side of the frame 4 of the anode frame 4″ and the side opposite the second side of the frame 5 of the cathode frame 5″ are arranged next to each other,

where anode frame 8 and cathode frame 11 are connected to each other,

whereby the first opening 6 and the second opening 9 are connected to each other,

wherein the first opening 6 is larger than the second opening 9 and wherein the anode frame 8 and the cathode frame 11 are arranged such that the side opposite the first side of the frame 4 of the anode frame 4″ and the side opposite the second side of the frame 5 of the cathode frame 5″ form a step 12 at the transition from the anode frame 8 to the cathode frame 11.

In the frame 1 according to the invention, the step 12 is preferably part of the cathode frame 11. In the frame 1 according to the invention, the step 12 preferably adjoins the second opening 9. In the frame 1 according to the invention, the step 12 preferably frames the second opening 9. In the frame 1 according to the invention, the step 12 preferably forms a planar third surface as a support surface for the solid-state electrolyte, for example a membrane 13. In the frame 1 according to the invention, the step 12 is preferably part of the cathode frame 11 and forms a planar third surface as a support surface for the solid-state electrolyte, for example a membrane 13. In the frame 1 according to the invention, the step 12 is preferably part of the cathode frame 11, adjoins the second opening 9, frames the second opening 9 and forms a planar third surface as a support surface for the solid-state electrolyte, for example a membrane 13.

According to the invention as membrane 13 preferably an ion-conducting membrane can be used.

The anode frame 8 comprises a core 21 and a coating made of sealing material 22. Preferably, the anode frame 8 comprises a core 21 made of metal or another suitable material and wherein the core 21 is coated with coating made of sealing material 22. The core 21 of the anode frame 8 is fully or partially coated with coating made of sealing material 22. The cathode frame 11 comprises a core 21 and coating made of sealing material 22. Preferably, the cathode frame 11 comprises a core 21, preferably made of metal or another suitable material and wherein the core 21 is coated with coating made of sealing material 22. The core 21 of the cathode frame 11 is completely or partially coated with coating made of sealing material 22. Any sealing material is suitable as coating made of sealing material 22, for example rubber, in particular ethylene propylene diene rubber (EPDM). For example, the coating made of sealing material 22 may comprise EPDM or consist of EPDM. The coating made of sealing material 22 is preferably a seal or acts as a seal in an electrochemical cell 2 or in a stack type device 23. The subject of the invention is a frame 1 for an electrochemical cell 2 with a core 21, preferably made of metal, wherein the core 21 is coated with sealing material, preferably rubber, for example EPDM (FIGS. 3a and 3b). The core 21 of the anode frame 8 is completely or partially coated with coating made of sealing material 22, in particular seal. The core 21 of the cathode frame 11 is completely or partially coated with a coating made of sealing material 22, in particular seal. Any sealing material is suitable as a seal, for example rubber, in particular ethylene propylene diene rubber (EPDM). For example, the seal can comprise EPDM or consist of EPDM.

The core 21 of the anode frame 8 preferably comprises or consists of metal. The core 21 of the cathode frame 11 preferably comprises or consists of metal. A core 21 made of metal provides good mechanical stability. Alternatively, other materials with similar mechanical properties can be used for the core 21. For example, high-strength plastic (PEEK), polytetrafluoroethylene (PTFE), in particular reinforced PTFE or molecularly reinforced PTFE. The coating made of sealing material 22, preferably rubber, for example ethylene propylene diene rubber (EPDM), creates the sealing effect, i.e. the sealing material acts as a seal.

In preferred embodiments, the entire surface of the core 21 of the anode frame 8 is coated with coating made of sealing material 22. In further preferred embodiments, at least 90%, preferably at least 95% or more of the surface of the core 21 of the anode frame 8 is coated with coating made of sealing material 22. In preferred embodiments, the entire surface of the core 21 of the cathode frame 11 is coated with coating made of sealing material 22. In further preferred embodiments, at least 90%, preferably at least 95% or more of the surface of the core 21 of the cathode frame 11 is coated with coating made of sealing material 22. In these embodiments, the sealing surface is very large.

In alternative embodiments, less than 90% of the surface of the core 21 of the anode frame 8 is coated with coating made of sealing material 22. In further alternative embodiments, less than 90% of the surface of the core 21 of the cathode frame 11 is coated with coating made of sealing material 22. However, in these alternative embodiments, the areas of the surface of the core 21 of the anode frame 8 and/or the core 21 of the cathode frame 11 are coated with coating made of sealing material 22, which are necessary to enable complete sealing of the electrolytic cell 2. Preferably, in these alternative embodiments, at least the areas of the surface of the core 21 of the anode frame 8 and/or the core 21 of the cathode frame 11 surrounding the first opening 6 and/or the second opening 9 are coated with coating made of sealing material 22. For example, an area of the surface of the core 21 of the anode frame 8 from 0.5 cm to 2.5 cm, preferably from 1 cm to 2 cm, for example 1.5 cm, which directly surrounds the first opening 6. For example, an area of the surface of the core 21 of the cathode frame 11 from 0.5 cm to 2.5 cm, preferably from 1 cm to 2 cm, for example 1.5 cm, which directly surrounds the second opening 9.

The metal provides good mechanical stability, whereas the coating made of sealing material 22, preferably rubber, for example EPDM, produces the sealing effect. The fact that preferably the entire or at least 90%, for example at least 95% or more of the surface of the core 21 made of metal of the anode frame 8 or that preferably the entire or at least 90%, for example at least 95% or more of the surface of the core 21 made of metal of the cathode frame 11 is coated with sealing material, preferably rubber, for example EPDM, means that the sealing surface is very large.

A further advantage of a stable core 21, for example made of metal and the coating made of sealing material 22, is that the components such as anode 7 and cathode 10 can be pressed into the frame 1, in particular into the anode frame 8 and the cathode frame 11 (press fit). This prevents deformation of the frame 1 or frames 1 in the electrochemical cell 2 or the stack type device 23 during the conversion of substances to generate electricity or during the conversion of substances using electricity under high pressure or under differential pressure, for example electrolysis, which is carried out at a differential pressure of up to 40 bar. The formation of a larger gap 17 between individual components inside the frame 1 in the electrochemical cell 2 or the frames 1, which are comprised in a stack-type device 23, and between individual components and the frame 1 or the frames 1. For example, a larger gap 17 is not formed between the cathode 10 and the frame 1 and/or between the anode 7 and the frame 1 (FIG. 8).

The metal used for the core 21 of anode frame 8 and/or cathode frame 11 can be stainless steel, for example, stainless steel with a thickness of 0.01 to 1 mm, preferably 0.5 mm. The coated core 21 of the anode frame 8, i.e. core 21 and coating made of sealing material 22 together and/or the coated core 21 of the cathode frame 11, i.e. core 21 and coating made of sealing material 22 together, can for example have a thickness of 1 to 5 mm, preferably 2 to 3 mm, for example 2.2 mm. Materials with comparable properties, such as highly reinforced plastic, for example PTFE, molecularly reinforced PTFE, are also suitable for the core 21.

The coating made of sealing material 22 has a layer thickness. The thickness of the coating made of sealing material 22 is, for example, 1 to 4.5 mm, for example 2 to 3 mm. Preferably, the thickness of the coating made of sealing material 22 surrounding the core 21 of the anode frame 8 is the same everywhere. Preferably, the thickness of the coating made of sealing material 22 surrounding the core 21 of the cathode frame 11 is the same everywhere. In particular embodiments, the core 21 of the anode frame 8 has areas that have a reduced layer thickness of the coating made of sealing material 22″ compared to the layer thickness of the coating made of sealing material 22 (FIG. 10b to 10d, FIG. 14, FIGS. 16 and 17). In particular embodiments, the core 21 of the cathode frame 11 has areas that have a reduced layer thickness of the coating made of sealing material 22″ compared to the layer thickness of the coating made of sealing material 22. For example, the layer thickness of the coating made of sealing material 22″ is reduced by 1 mm compared to the layer thickness of the coating made of sealing material 22. For example, the layer thickness of the coating made of sealing material 22 is 4 mm and the reduced layer thickness of the coating made of sealing material 22″ is 3 mm. For example, the layer thickness of the coating made of sealing material 22 is 10 mm or less, preferably 5 mm, 3 mm, 2 mm or less 1.5 mm, 1 mm or less. For example, the reduced thickness of the coating made of sealing material 22 is 9 mm or less, preferably 4 mm, 2.8 mm, 1.9 mm or less 1.45 mm, 0.95 mm or less. For example, the difference in layer thickness between the layer thickness of the coating made of sealing material 22 and the reduced layer thickness of the coating made of sealing material 22″ is 1 mm, 0.7 mm, 0.5 mm or less, for example 0.3 mm, 0.2 mm, 0.1 mm, 0.05 mm or less.

For example, the first opening 6 is at least 0.5 mm or 1 mm, for example 2 mm or more, 0.5 cm, preferably 1 cm, particularly preferably 1.5 cm or more larger than the second opening 9. Preferably, the step 12, which is formed inside the cathode frame 11 by the larger first opening 6 and the smaller second opening 9, has the same width everywhere (FIG. 7b). Alternatively, the step 12 can have different widths at different points. The width of the step 12 and thus of the planar third surface for holding the solid-state electrolyte, for example a membrane 13, can have the same or different widths at different points.

The anode frame 8 can, for example, have the external dimensions 20 to 70 cm by 20 to 70 cm, for example 50 cm by 50 cm or 35 cm by 35 cm. The first opening 6 can, for example, have the dimensions 11 to 51 cm by 11 to 51 cm, for example 21 cm by 21 cm or 15 by 15 cm (FIG. 9b). The cathode frame 11 can, for example, have the external dimensions 20 to 70 cm by 20 to 70 cm, for example 50 cm by 50 cm or 35 cm by 35 cm. The second opening 9 can have the dimensions 10 to 50 cm by 10 to 50 cm, for example 20 cm by 20 cm or 14 cm by 14 cm (FIG. 9a). Preferably, the same external dimensions are selected for anode frame 8 and cathode frame 11. The dimensions for the first opening 6 and the second opening 9 are selected so that the first opening 9 is larger than the second opening 9, so that when anode frame 8 and cathode frame 1 interact as frame 1, a step 12 is formed.

Various frame shapes are known to the skilled person, in which the frame 1, the anode frame 8 and the cathode frame 11 can be designed, for example square, rectangular, round. Due to the fact that the shape of the frame 1 can be freely selected, the contact pressure in certain areas of the frame 1 can be adjusted by increasing or reducing the thickness of the frame, preferably by reducing the thickness of the coating made of sealing material 22. The thickness of the coating made of sealing material 22 can be increased. This allows areas to be created in which the layer thickness of the coating made of sealing material 22 on the core 21 is thicker than in other areas of the anode frame 8 or cathode frame 11. The layer thickness of the coating made of sealing material 22 can be reduced. As a result, areas can be created in which the layer thickness of the coating made of sealing material 22 on the core 21 is less than in other areas of the anode frame 8 or cathode frame 11. Areas with different layer thicknesses of the coating made of sealing material 22 can take over functions in the frame 1 according to the invention.

In order to avoid transverse leaks, the pressure on the active area can be increased, for example, by a circumferential increase 26″ in the layer thickness of the coating made of sealing material 22, such as a circumferential rubber increase. A circumferential increase 26″ in the layer thickness of the coating made of sealing material 22 can have a width of 1 mm, for example. The difference in the layer thickness between the coating made of sealing material 22 and the circumferential increase 26″ can be 1 mm, 0.5 mm, 0.1 mm, 0.05 mm, for example.

Subject of the invention is a frame 1 wherein the coating made of sealing material 22 in certain areas of the anode frame 8 and/or in certain areas of the cathode frame 11 has a reduced layer thickness of the coating made of sealing material 22″ compared to the layer thickness of the coating made of sealing material 22, for example to reduce the contact pressure.

Subject of the invention is a frame 1, wherein the coating made of sealing material 22 has, in certain areas of the anode frame 8, for example to increase the sealing effect, a circumferential elevation 26″ which surrounds the first opening 6. Subject of the invention is a frame 1, wherein the coating made of sealing material 22 in certain regions of the cathode frame 11 has a circumferential elevation 26″ surrounding the second opening 9, for example to increase the sealing effect.

In a square anode frame 8, the first opening 6 can be formed by a first side 27, a second side 28, a third side 29 and a fourth side 30. In a square cathode frame 11, the second opening 9 can be formed by a first side 27″, a second side 28″, a third side 29″ and a fourth side 30″.

Further components that are part of an electrochemical cell 2 or a stack type device 23 can be saved by installing the components as structures in the frame 1, the anode frame 8, the cathode frame 11, in particular the coating made of sealing material 22 with which the core 21 of the anode frame 8 and the cathode frame 11 are coated. For example, the coating made of sealing material 22 can be a coating made of rubber and comprise a rubber lip 25, which is arranged, for example, in the area of the connections for individual voltage measurements. In this way the insulating foil can be saved. The invention relates to frames 1 in which the coating made of sealing material 22 of the anode frame 8 and/or the sealing of the cathode frame 11 take over other functions in addition to the sealing function. For this purpose, the coating made of sealing material 22 of the anode frame 8 and/or the cathode frame 11 comprises corresponding embodiments, for example a rubber lip 25.

Other required parts can be manufactured directly from the coating made of sealing material 22, so that the number of individual parts required to manufacture an electrochemical cell 2 or a stack type device 23 is reduced. This significantly reduces the effort involved in assembling a stack type device 23. Likewise, the insertion of means for connecting the anode frame 8 and cathode frame 11, for example pin 19 and hole 18, eliminates the need for an additional assembly aid.

In preferred embodiments, the coating made of sealing material 22 comprises one or more channels type II 15. A channel type II 15 is designed as an area in the coating made of sealing material 22 which has a reduced layer thickness of the coating made of sealing material 22″ compared to the layer thickness of the coating made of sealing material 22. A channel type II 15 is therefore a depression or recess in the coating made of sealing material 22 that does not contribute to the sealing effect. Neighbouring individual channels type II 15 are separated by elevations 26. An elevation 26 between two adjacent channels type II 15 is, for example, an area in which the core 21 has a coating made of sealing material 22 that does not have a reduced layer thickness. The reduced layer thickness of the coating made of sealing material 22″ in the area in which individual channels type II 15 are arranged can be selected independently of the reduced layer thickness of the coating made of sealing material 22″ in other areas of the coating surrounding the core 21, which may have a reduced layer thickness of the coating. In particular embodiments, the core 21 has no coating made of sealing material 22 in the one or more areas that represent one or more channels type II 15.

In preferred embodiments, the first opening 6, which is framed by the anode frame 8, and the second opening 9, which is framed by the cathode frame 11, are of different sizes (FIGS. 7b, 8, 9a and 9b). For example, the cathode frame 11 is smaller and the anode frame 8 is larger. This means that at differential pressure, for example a differential pressure of 40 bar, i.e. when only the cathode side of the electrochemical cell 2 is operated under pressure, or when only the cathode sides of the stack type devices 23 are operated under pressure, the liquid pressure or the gas pressure (depending on which medium is under pressure, it is gas or liquid) does not press on the gap 17 between anode frame 8 and anode 7. The solid-state electrolyte, for example the membrane 13, is then only pressed against the anode 7 and mechanically supported on the anode 7. Being pressed or crawl 24 of the solid-state electrolyte, for example the membrane 13, into the gap 17 between frame 1, for example the anode frame 8, and the electrode, for example anode 7 can be prevented in this way.

In alternative embodiments of the frame 1, the electrochemical cell 2, the stack type device 23, the anode frame 8 is smaller and the cathode frame 11 is larger. In these alternative embodiments, the step 12 is formed by the anode frame 8. As a result, at differential pressure, for example a differential pressure of 40 bar, i.e. when only the anode side of the electrochemical cell 2 is operated under pressure, or when only the anode sides of the stack type 23 devices are operated under pressure, the medium pressure does not press on the gap 17 between the cathode frame 11 and the cathode 10. The solid-state electrolyte, for example the membrane 13, is then only pressed against the cathode 10 and mechanically supported on the cathode 10. Being pressed or crawl 24 of the solid-state electrolyte, for example the membrane 13, into the gap 17 between the frame 1, for example the cathode frame 11, and the electrode, for example the cathode 11 can be prevented in this way.

In preferred embodiments, the frame 1 according to the invention comprises two different types of channels for the supply and removal of water and gas.

Preferably, the frame 1 comprises one or more channels type I 14 for the supply and removal of liquid and gas into the frame 1 and out of the frame 1, respectively. Preferably, the channels type I 14 channels are not directly connected to the first opening 6 in the anode frame 8 or the second opening 9 in the cathode frame 11. Preferably, the core 21 of the anode frame 8 comprises one or more channels type I 14. Preferably, the core 21 of the cathode frame 11 comprises one or more channels type I 14. Preferably, the channels type I 14 are coated with coating made of sealing material 22.

Furthermore, the frame 1 preferably comprises one or more channels type II 15 for the supply of liquid and gas into the first opening 6, for the removal of liquid and gas out of the first opening 6, for the supply of liquid and gas into the second opening 9, for the removal of liquid and gas out of the second opening 9. Preferably, channels type II 15 connect channels type I 14 with the first opening 6. Preferably, channels type II 15 connect channels type I 14 with the second opening 9.

Depending on the application, the liquids and gases supplied in and removed out differ.

In preferred embodiments, the coating made of sealing material 22 with which the whole or parts of the anode frame 8 are coated comprises one or more channels type II 15. In other embodiments, the core 21 of the anode frame 8 comprises one or more channels type II 15. In preferred embodiments, the coating made of sealing material 22 with which the whole or parts of the cathode frame 11 are coated comprises one or more channels type II 15. In other embodiments, the core 21 of the cathode frame 11 comprises one or more channels type II 15. An advantage of this embodiment is the manufacturing cost. In preferred embodiments, the channels type II 15 are not milled out of each anode frame 8 and each cathode frame 11 but are transferred once into a tool. A suitable tool is, for example, the negative for the anode frame 8 or the negative for the cathode frame 11. For example, the arrangement of the channels type II 15, their diameter, their length and possibly other parameters are transferred to the tool. The tool can be used to transfer the channels type II 15 into the seal 22, for example as if they were stamped into the sealing material, preferably the rubber, for example EPDM, using a stamp. With the aid of the tool the core 21 of the anode frame 8 or the core 21 of the cathode frame 11 is encased by vulcanization.

In preferred embodiments of the frame 1, the anode frame 8 comprises on the surface of the first side of the frame 4 one or more channels type II 15 which are connected to the channel type I 14 and which connect the channel type I 14 to the first opening 6 and which, when the frame 1 is installed in an electrochemical cell 2 or a stack type device 23, are arranged in the direction of the BPP 16 and wherein the side opposite to the first side of the frame of the anode frame 4″ does not comprise channels type II 15.

In preferred embodiments of the frame 1, the cathode frame 11 comprises on the surface of the second side of the frame 5 one or more channels type II 15 which are connected to a channel type I 14 and connect the channel type I 14 to the second opening 9 and which, when the frame 1 is installed in an electrochemical cell 2 or a stack type device 23, are arranged in the direction towards the BPP 16 and wherein the side opposite to the second side of the frame of the cathode frame 5″ does not comprise channels type II 15.

In preferred embodiments, the frame 1 according to the invention comprises one or more channels type I 14 for the supply and removal of water and gas and one or more channels type II 15, wherein the one or more channels type I 14 are not connected to the first opening 6 in the anode frame 8 or the second opening 9 in the cathode frame 11. In preferred embodiments of the frame 1, the anode frame 8 comprises on the surface of the first side 4 one or more channels type II 15 which are connected to the one or more channels type I 14 and which connect the one or more channels type I 14 to the first opening 6 and which, when the frame 1 is installed in an electrochemical cell 2 or a stack type device 23, are arranged in the direction towards the BPP 16 and wherein the side opposite to the first side 4 of the anode frame 4″ does not comprise any channels type II 15. In preferred embodiments of the frame 1, the cathode frame 11 comprises, on the surface of the second side 5, one or more channels type II 15 which are connected to one or more channels type I 14 and which connect the one or more channels type I 14 to the second opening 9 and which, when the frame 1 is installed in an electrochemical cell 2 or a stack type device 23, are arranged in the direction towards the BPP 16 and wherein the side opposite the second side 5 of the cathode frame 5″ does not comprise any channels type II 15.

In preferred embodiments, the frame 1 according to the invention comprises at least two channels type I 14 for the supply and removal of liquid and gas and at least two channels type II 15, wherein the channels type I 14 are not connected to the first opening 6 in the anode frame 8 or the second opening 9 in the cathode frame 11. In preferred embodiments of the frame 1, the anode frame 8 comprises on the surface of the first side of the frame 4 at least two channels type II 15 which are connected to the at least two channels type I 14 and which connect the channels type I 14 to the first opening 6 and which, when the frame 1 is installed in an electrochemical cell 2 or a stack type device 23, are arranged in the direction towards the BPP 16 and wherein the side opposite to the first side of the frame of the anode frame 4″ does not comprise channels type II 15. Preferably, a plurality of channels type II 15 arranged on the first side of the frame 4 connect a channel type I 14 to the first opening 6. In preferred embodiments of the frame 1, the cathode frame 11 comprises on the surface of the second side of the frame 5 at least two channels type II 15 which are connected to at least two channels type I 14 and which connect the channels type I 14 to the second opening 9 and which, when the frame 1 is installed in an electrochemical cell 2 or a stack type device 23, are arranged in the direction towards the BPP 16 and wherein the side opposite to the second side of the frame of the cathode frame 5″ does not comprise channels type II 15. Preferably, a plurality of channels type II 15 arranged on the second side of the frame 5 connect a channel type I 14 to the second opening 9.

The channels type II 15, which connect the channels type I 14 with the first opening 6 and the second opening 9, i.e. which connect the anode 7 and the cathode 10 with the channels type I 14 for the supply and removal of liquid and gas, are arranged in the anode frame 8 and/or in the cathode frame 11 such that they point in the direction of the BPP 16 and not in the direction of the solid-state electrolyte, for example the membrane 13. If gas or liquid flows through the channels of type I 14, the solid-state electrolyte, for example the membrane 13, is not affected by this, because the side of the anode frame 7 and the side of the cathode frame 11 on which the solid-state electrolyte, for example the membrane 13, rests does not comprise any channels of type II 15, i.e. no channels type II 15 in the immediate vicinity of the first opening 6 or the second opening 9 in the area in which the solid-state electrolyte, for example the membrane 13, is arranged and is exposed to a differential pressure of up to 40 bar during electrolysis. The solid-state electrolyte, for example the membrane 13, rests on a smooth flat surface without channels and is therefore well supported even at a differential pressure of up to 40 bar. At the same time, the anode compartment (the anode compartment is formed by anode frame 7, solid-state electrolyte, for example membrane 13 and BPP 16), the cathode compartment (the cathode compartment is formed by cathode frame 11, solid-state electrolyte, for example membrane 13 and BPP 16) and the entire electrochemical cell 2 are completely sealed, even at a differential pressure of up to 40 bar, so that no gas or liquid can escape.

In exemplary embodiments, the frame 1 comprises two to one thousand or more channels type II 15, for example at least one hundred channels type II 15, preferably at least two hundred channels type II 15, or more or less, for example 50 or less. Preferably, at least half of the channels type I 14 are connected to the first opening 6 or the second opening 9 by means of channels type II 15. Preferably, at least two or more, for example four, 10 or more channels type II 15 connect channels type I 14 to the first opening 6. Preferably, at least two or more, for example four, 10 or more channels type II 15 connect a channel type I 14 to the second opening 9.

For example, the channels type II 15, which are connected to the first opening 6, are arranged next to each other on the first side of the frame 4. The distance between two adjacent channels type II 15 is, for example, ≤5 mm, ≤3 mm, preferably ≤2 mm or less. For example, the channels type II 15 between channel type I 14 and first opening 6 are arranged in a fan shape on the first side of the frame 4.

For example, the channels type II 15, which are connected to the second opening 9, are arranged next to each other on the second side of the frame 5. The distance between two adjacent channels type II 15 is, for example, ≤5 mm, ≤3 mm, preferably ≤2 mm or less. For example, the channels type II 15 between channel type I 14 and second opening 9 are arranged in a fan shape on the second side of the frame 5.

The channels of the frame 1 are designed so that the liquid is distributed through the channels of type I 14 within a stack type device 23 and the liquid reaches each individual electrochemical cell 2 through channels of type II 15. The channels type I 14 are preferably arranged at regular intervals along or parallel to the first opening 6 in the anode frame 8. The channels of type I 14 are preferably arranged at regular intervals along or parallel to the second opening 9 in the cathode frame 11. For example, there are 20 or more or fewer, e.g. five channels type I 14 on each side of a square first opening 6 or on each side of a square second opening 9.

In particularly preferred embodiments, the channels type I 14 are arranged in such a way that they each supply the same portion and thus the same area of the first opening 6 and the second opening 9 of an electrochemical cell 2 or the first openings 6 and the second openings 9 of a stack type device 23 with the inflowing medium (liquid, gas).

In particularly preferred embodiments, continuous channels type II 15 with preferably constant opening diameters of preferably 5 mm or less, particularly preferably <2 mm, lead from each channel type I 14 or a part of the channels type I 14 to the first openings 6 or to the second openings 9. These channels type II 15 are arranged in a fan shape, for example, so that the channels type II 15 are evenly distributed over the first openings 6 or second openings 9. Other arrangements of the channels type II 15 in the area between the first opening 6 or the second opening and the channel type I 14, which passes through the channels type II 15, are possible. By limiting the width of the channels type II 15 to 5 mm or less, preferably two mm or less, sufficient contact pressure is transmitted to the opposite frame 1 in the area of the channels type II 15.

The uniform distribution of the channels type I 14 and type II 15 over the entire width of the frame 1 along the first opening 6 or along the second opening 9, for example along the entire width of the first side of the first opening 27 and along the entire width of the third side of the first opening 29 (FIG. 10a) leads to a particularly good distribution of the liquid over the entire active cell area (=first opening 6+second opening 9) of the electrochemical cell 2. Liquid flows evenly through the electrochemical cell 2. Since a large proportion of the incoming liquid is used for cooling, an even distribution of the channels type II 15 leads to a homogeneous heat dissipation. This arrangement of the channels type II 15 allows the heat generated during the electrochemical reaction to be dissipated evenly. The dissipation of the reaction heat is a critical parameter for an electrochemical cell 2 or a stack type device 23.

In accordance with the invention, stack type devices 23 with different designs and structures are included.

Included are frames 1, electrochemical cells 2, pre-assembled modules 20 and stack type devices 23 in which the individual channels type II 15 are adapted to provide a higher or lower pressure drop in the flow of the fluid compared to the other channels type II 15 of the respective frame 1, the respective electrochemical cell 2, the respective stack type device 23. For example, the external channels type II 15 are adapted accordingly, i.e. for example the channels type II 15 located at the edge of the arrangement of the channels type II 15 on the first side of the frame 4, e.g. the channels type II 15 located at the edge of the arrangement of the channels type II 15 with respect to the first side of the first opening 27 are adapted such that either a higher or a lower pressure loss of the liquid flowing through is produced compared to the other channels type II 15 of the frame 1, the electrochemical cell 2, the pre-assembled module 20, the stack type device 23. This can be achieved, for example, by reducing the opening cross-section of the channels type II 15. This is necessary, for example, if the pressure loss in the channels type I 14 is not uniform, and if the channels type II 15 are uniform, then certain areas of the active cell area (=first opening 6+second opening 9) with a higher volume flow of liquid flowing through the channels type II 15 in question, which are connected to the channels type I 14 in which the flowing liquid has a higher pressure. Without an adaptation of the channels type II 15, the cooling in the active cell area could then become more uneven, for example, due to the liquid flowing through. This can be compensated for by adapting the channels type II 15. The cross-sections of the relevant channels type II 15 can, for example, be adapted, e.g. reduced, to compensate for the differences in fluid pressure in the channels type I 14. Preferably, a uniform or homogeneous fluid pressure is generated over the entire active cell area. With channels type II 15, which are e.g. individually adapted, which e.g. have different opening cross-sections, the different pressure loss in the channels type I 14 can be compensated and the flow through all channels type II 15 can be homogenized.

According to the invention, frames 1, electrochemical cells 2, pre-assembled modules 20 and stack type devices 23 are comprised, in which the individual channels type II 15 of the respective frame 1, the respective electrochemical cell 2, the respective pre-assembled module 20, the respective stack type device 23 are arranged such that each channel type II 15 supplies liquid to an area of the same size of the active cell area.

According to the invention, frames 1, electrochemical cells 2, pre-assembled modules 20 and stack type devices 23 are comprised, wherein the individual channels type II 15 of the respective frame 1, the respective electrochemical cell 2, the respective pre-assembled module 20, the respective stack type device 23 are designed such that all channels type II 15 can transport the same amount of liquid or gas in the same time, i.e. all channels type II 15 are the same. This can be achieved, for example, by the fact that all channels type II 15 have the same cross-section through which liquid or gas can flow. Preferably, the channels type II 15 are arranged in such a way that each channel type II 15 supplies an area of the same size of the active cell area with liquid or gas. Particularly preferably, the channels type II 15 are arranged in such a way that each channel type II 15 supplies an area of the same size of the active cell area with liquid or gas and all channels type II 15 are the same. In this way, the entire active cell area can be evenly supplied with liquid or gas.

The number, shape and arrangement of channels type I 14 and other parameters relating to channels type I 14 and the number, shape and arrangement of channels type II 15 and other parameters relating to channels type II 15 can be adapted as required, e.g. to the frame shape used.

In the frame 1 according to the invention, anode frame 8 and cathode frame 11 are connected to each other via connecting elements. Corresponding connecting elements are known to the person skilled in the art. In preferred embodiments of the frame 1, the anode frame 8 comprises one or more connecting elements, for example pins 19, and the cathode frame 11 comprises one or more connecting elements, for example holes 18, wherein the pin or pins 19 and the hole or holes 18 are arranged such that the hole or holes 18 in the cathode frame 11 can be plugged onto the pin or pins 19 in the anode frame 8 and the anode frame 8 and cathode frame 11 can thereby be connected to one another.

Subject of the invention is an electrochemical cell 2 for operation under differential pressure of up to 40 bar for generating high-pressure gas and liquids, comprising a solid-state electrolyte, for example a membrane 13, anode 7, cathode 10, wherein the electrochemical cell 2 comprises a frame 1 according to the invention, wherein the first opening 6 in the anode frame 8 comprises the anode 7 and the second opening 9 in the cathode frame 11 comprises the cathode 10 and wherein the solid-state electrolyte, for example the membrane 13 is arranged between the side opposite the first side of the frame 4 of the anode frame 4″ and the side opposite the second side of the frame 5 of the cathode frame 5″, wherein one side of the solid-state electrolyte, for example the membrane 13 rests on the anode 7 and the other side of the solid-state electrolyte, for example the membrane 13, rests on the step 12 and the cathode 10 (FIGS. 7b and 7c). When the electrolytic cell 2 is operated under differential pressure, the differential pressure does not act on the solid-state electrolyte, for example the membrane 13, in the area of the gap 17 between the anode frame 8 and the anode 7. This prevents the solid-state electrolyte, for example the membrane 13, from being pressed or crawling 24 into the gap 7 (FIGS. 8 and 8a).

In preferred embodiments, the electrochemical cell 2 according to the invention comprises a solid-state electrolyte, for example a membrane 13 having a thickness of less than 80 μm, for example a membrane 13 having a thickness of 50 μm or less, particularly preferably a membrane 13 having a thickness of less than 20 μm, for example 15 μm or less. In particularly preferred embodiments, the electrochemical cell 2 according to the invention comprises a solid-state electrolyte, for example a membrane 13, preferably an ion-conducting membrane 13 with a thickness of less than 80 μm, for example an ion-conducting membrane 13 with a thickness of 50 μm or less, particularly preferably an ion-conducting membrane 13 with a thickness of less than 20 μm, for example 15 μm or less.

In the electrochemical cell 2 according to the invention, the coatings made of sealing material 22, for example the coating made of rubber, preferably the coating made of EPDM of the core 21 of the anode frame 8, the coatings made of sealing material 22, for example the coating made of rubber, preferably the coating made of EPDM of the core 21 of the cathode frame 11 and the step 12 interact with the solid-state electrolyte, for example the membrane 13 (FIGS. 7c and 8a) and completely seal the electrochemical cell 2 and the anode compartment and the cathode compartment without the solid-state electrolyte, for example the membrane 13, being pressed or crawl 24 into the gap 17 between the anode frame 8 and the anode 7. The special arrangement of the channels type II 15 completely ensures both the supply and removal of liquid and gas as well as the stability of the solid-state electrolyte, for example the membrane 13, and a complete sealing of the electrochemical cell 2. The frame 1 according to the invention therefore enables the use of solid-state electrolytes, for example membranes 13 with a thickness of less than 80 μm, for example with a thickness of 50 μm, preferably with a thickness of less than 20 μm, for example 15 μm or less. These solid-state electrolytes, for example membranes 13, are referred to as thin solid-state electrolytes or thin membranes 13. With the frame 1 according to the invention, electrochemical cells 2 can be produced with a thinner solid-state electrolyte, for example a thinner membrane 13 than usual in the prior art. In addition, these electrochemical cells 2 can be operated in such a way that the liquid or gas on one side of the cell is accumulated at pressures of up to 40 bar without damaging the solid-state electrolyte, for example a membrane 13, or causing the electrochemical cell 2 to leak.

In preferred embodiments, the anode 7 is designed such that the BPP 16 is connected to the anode 7, this is referred to as BPP/anode 36 according to the invention. The use of BPP/anode 36 not only facilitates assembly, but also reduces the contact resistance between the individual parts.

In preferred embodiments, the anode 7 comprises at least one coarse distributor and at least one fine distributor for the process media, in particular the liquid. The coarse distributor efficiently distributes the liquid over the entire cell area (i.e. the first opening and the second opening 6+9). The fine distributor transports the liquid to the solid-state electrolyte, for example to the membrane 13, enables good electrical contact to the solid-state electrolyte, for example to the membrane 13, and at the same time mechanically supports the solid-state electrolyte, for example the membrane 13. An expanded metal, for example, can be used as a coarse distributor for the anode 7. A plate made of sintered powder, for example, can be used as the fine distributor for the anode 7. Coarse distributor and fine distributor, for example expanded metal and sintered metal, can be joined together, for example by resistance welding, to produce an anode 7. Alternatively, the powder can be sintered directly onto the expanded metal to produce an anode 7. The anode 7 can be connected to the BPP 16. Preferably, the BPP 16 is made of the same material as the anode 7. In particularly preferred embodiments, the BPP 16 and anode 7 are made of titanium. In alternative preferred embodiments, BPP 16 and anode 7 comprise at least 80% of the same material, e.g. titanium. The connection between BPP 16 and anode 7 can be realized, for example, by resistance welding, preferably at several points. In the BPP/anode 36, the surface of the BPP 16 corresponds to the outer surface of the frame 1 or the surface of the BPP/anode 36 essentially corresponds to the outer surface of the frame 1. The surface of the anode 7 in the BPP/anode 36 is adapted so that it fills the first opening 6 or fits into the first opening 6. Instead of two parts (BPP 16 and anode 7), only one part, the BPP/anode 36, is required for assembly. This means that one part is saved.

Depending on whether liquid or gas is transported via the electrode, the channels type I 14 on one side or two sides along the first opening 6 of the anode frame 8 can also be significantly smaller than the channels type I 14 on other sides along the first opening of the anode frame 8 (see FIG. 10b). For example, the channels type I 14 on the cathode side can be significantly smaller than on the anode side (see FIG. 10b to 10d). In order to save space and ensure the mechanical stability of the frame 1, channels type I 14 can, for example, be designed as a slot instead of a round hole. Different shapes and a corresponding adaptation are possible for the channels type I 14.

Subject of the invention is a pre-assembled module 20 for manufacturing a stack type device 23 comprising a frame 1 according to the invention. For example, subject of the invention is a pre-assembled module 20 for manufacturing a stack type device 23 comprising an anode frame 8, a cathode frame 11, a BPP 16, an anode 7 and a cathode 10,

wherein the anode frame 8 comprises a first side of the frame 4 with a planar first surface, a side opposite the first side of the frame 4 of the anode frame 4″ and a first opening 6 for receiving the anode 7, wherein the first opening 6 extends from the first side of the frame 4 to the side opposite the first side of the frame 4 of the anode frame 4″, and wherein the first opening 6 is surrounded by the anode frame 8, and wherein the anode frame 8 comprises at least one connecting element for connection to the cathode frame 11, for example a pin 19,

wherein the cathode frame 11 comprises a second side of the frame 5 with a planar second surface, a side opposite the second side of the frame 5 of the cathode frame 5″ and a second opening 9 for receiving the cathode 10, wherein the second opening 9 extends from the second side of the frame 5 to the side opposite the second side of the frame 5 of the cathode frame 5″ and is surrounded by the cathode frame 11, and wherein the cathode frame 11 comprises at least one connecting element for connection to the anode frame 8, for example a hole 18 for receiving the pin 19 of the anode frame 8, wherein the BPP 16 is arranged between the first side of the frame 4 and the second side of the frame 5, wherein the BPP 16 can be part of a BPP/anode 36,

wherein the anode frame 8 comprises a core 21 and coating made of sealing material 22, wherein the core 21 is completely or partially coated with coating made of sealing material 22 and wherein, for example, the core 21 comprises metal or consists of metal and the coating made of sealing material 22 comprises, for example, sealing material or consists of sealing material, for example rubber, preferably EPDM, and wherein preferably the BPP 16 is connected to the anode 7 to form a BPP/anode 36 and the anode 7 or the BPP/anode 36 is inserted or pressed into the first opening 6 and the anode 7 is framed by the anode frame 8,

the cathode frame 10 comprises a core 21 and coating made of sealing material 22, wherein the core 21 is wholly or partially coated with coating made of sealing material 22 and wherein, for example, the core 21 comprises metal or consists of metal and the coating made of sealing material 22 comprises, for example, sealing material or consists of sealing material, for example rubber, preferably EPDM, and wherein the cathode 10 is inserted or pressed into the second opening 9 and is framed by the cathode frame 11, whereby anode frame 8 and cathode frame 11 are connected via the connecting elements of the anode frame 8 and the cathode frame 11, for example the pin 19 of the anode frame 8 is inserted in the hole 18 of the cathode frame 11 and anode frame 8 and cathode frame 11 are thereby connected to one another,

wherein the first opening 6 is larger than the second opening 9 and wherein the anode frame 8 and the cathode frame 11 are arranged such that the first side of the frame 4 and the second side of the frame 5 form a step 12 at the transition from the anode frame 8 to the cathode frame 11, wherein preferably the step 12 is the part of the cathode frame 11 which preferably adjoins the second opening 9 and preferably frames the second opening 9, and wherein the step 12 preferably forms a planar third surface as a support surface for the solid-state electrolyte, for example the membrane 13, wherein the BPP 16 or the BPP 16 of the BPP/anode 36 rests on one side on the anode 7 and the anode frame 8 and rests on the other side on the cathode 10, the cathode frame 11 and the step 12. The pre-assembled module 20 preferably comprises the channels type I 14 and type II 15 described in this application for the supply and removal of liquid and gas, which can be arranged as described.

Subject of the invention is a method for manufacturing a pre-assembled module 20 comprising a frame 1 according to the invention. Subject of the invention is, for example, a method for manufacturing a pre-assembled module 20, comprising the method steps
a) a core 21, preferably made of metal, is produced for the anode frame 8, the core 21 comprising a first side of the frame 4 having a planar first surface and a side opposite the first side of the frame 4 of the anode frame 4″, the first side of the frame 4 and the side opposite the first side of the frame 4 of the anode frame 4″ comprising a first opening 6 which extends from the first side of the frame 4 to the side opposite the first side of the frame 4 of the anode frame 4″ and which is framed by the anode frame 8, and which comprises one, two or more channels of type I 14 for the supply and removal of liquid and gas, wherein the channel or the channels type I 14 are not connected to the first opening 6 in the anode frame 8, and wherein the anode frame 8 comprises at least one connecting element for connection to the cathode frame 11, e.g. a pin 19,
b) the surface of the core 21 produced according to a) for the anode frame 8 is completely or partially, for example at least 90% of the surface of the core 21 produced according to a) for the anode frame 8, for producing a coating made of rubber as a coating made of sealing material 22 by vulcanization is coated with natural or synthetic rubber and is then vulcanized, and a coating made of rubber is thereby produced on the entire surface or on parts of the surface of the core 21, preferably a coating made of EPDM, wherein in the coating made of rubber one, two or more channels of type II 15 are produced on the surface of the first side of the frame 4, which are connected to one, two or more channels of type I 14 and which connect the channel or channels of type I 1414 with the first opening 6 and which, when the anode frame 8 is installed in an electrochemical cell 2 or a stack type device 23, are arranged towards the BPP 16 or the BPP side of the BPP/anode 36 and wherein no channels type II 15 are produced on the surface of the side opposite the first side of the frame 4 of the anode frame 4″,
c) the anode 7 and the BPP 16 or a BPP/anode 36 are placed or pressed into the anode frame 8 manufactured according to a) and b),
d) a core 21, preferably made of metal, is produced for the cathode frame 11, the core 21 comprising a second side of the frame 5 having a planar second surface and a side opposite the second side of the frame 5 of the cathode frame 5″, the second side of the frame 5 and the side opposite the second side of the frame 5 of the cathode frame 5″ comprising a second opening 9 which extends from the second side of the frame 5 to the side opposite the second side of the frame 5 of the cathode frame and which is framed by the cathode frame 11, and which comprises one, two or more channels of type I 14 for the supply and removal of liquid and gas, wherein the channels type I 14 are not connected to the second opening 9 in the cathode frame 11, and wherein the cathode frame 11 comprises at least one connecting element for connection to the anode frame 8, e.g. a hole 18,
e) the surface of the core 21 for the cathode frame 11 produced according to d) is completely or partially coated, for example at least 90% of the surface of the core 21 produced according to d) for the cathode frame 8, for producing a coating made of rubber as a coating made of sealing material 22 by vulcanization is coated with natural or synthetic rubber and is then vulcanized, and a coating made of rubber is thereby produced on the entire surface or on parts of the surface of the core 21, preferably a coating made of EPDM, wherein in the coating made of rubber one, two or more channels of type II 15 are produced on the surface of the second side of the frame 5, which are connected to one, two or more channels type I 14, and which connect the channel or channels of type I 14 with the second opening 9 and which, when the cathode frame 11 is installed in an electrochemical cell 2 or a stack type device 23, are arranged in the direction of the BPP 16 or the BPP side of the BPP/anode 36, and wherein no channels type II 15 are produced on the surface of the side opposite the second side of the frame 5 of the cathode frame 5″,
f) the cathode frame 11 produced according to d) and e) is connected to the anode frame 8, for example by the cathode frame 11 being plugged onto the anode frame 8 and the BPP 16 or the BPP of the BPP/anode 36 being arranged between the first side of the frame 4 and the second side of the frame 5 and then the cathode 10 being inserted or pressed into the cathode frame 11.

Subject of the invention is a method of manufacturing a stack type device 23 for converting or generating gases and liquids under pressure, comprising frames 1 according to the invention, pre-assembled modules 20 according to the invention, electrochemical cells 2. Subject of the invention is, for example, a method of manufacturing a stack type device 23 for operation under differential pressure for the conversion or generation of high-pressure liquid or high-pressure gas, comprising the method steps,
a) at least x pre-assembled modules 20 according to the invention and at least x+1 solid-state electrolytes, for example at least x+1 membranes 13, are stacked alternately one above the other, wherein a stack of pre-assembled modules 3 is produced, wherein in the stack of preassembled modules 3 one pre-assembled module 20 and one solid-state electrolyte, for example a membrane 13, are stacked alternately one above the other, and wherein one solid-state electrolyte, for example a membrane 13, is arranged on the top side and the bottom side of the stack of pre-assembled modules 3, and a solid-state electrolyte, for example a membrane 13, is arranged between each two adjacent pre-assembled modules 20, and wherein
b) then on one side of the stack of pre-assembled modules 3 a single anode 7′ is arranged parallel to an outer solid-state electrolyte, for example a membrane 13, and on the other side of the stack of pre-assembled modules 3 a single cathode 10′ is arranged parallel to an outer solid-state electrolyte, for example a membrane 13,
c) an end plate 33 is arranged parallel to the single anode 7′ and parallel to the single cathode 10′ and the stack produced is then compressed between the two end plates 33 to form a stack type device 23,
   where x is an integer and >2.

In preferred embodiments of a method of manufacturing the stack type device 23 according to the invention, one or more, preferably each of the x+1 solid-state electrolytes, for example each of the x+1 membranes 13 in the stack type device 23 has a thickness of less than 80 μm, preferably a thickness of less than 50 μm or less, more preferably a thickness of less than 20 μm or less, for example 15 μm or less, and wherein x is an integer and >2.

Subject of the invention is a stack type device 23 for operation under differential pressure for converting or generating high-pressure liquid or high-pressure gas, comprising one or more frames 1 according to the invention. Subject of the invention is a stack type device 23 comprising one or more pre-assembled modules 20 according to the invention. Subject of the invention is a stack type device 23 comprising one or more electrochemical cells 2 according to the invention.

Subject of the invention is, for example, a stack type device 23 for operation under differential pressure for the conversion or generation of high-pressure liquid or high-pressure gas, comprising x pre-assembled modules 20 according to the invention, x+1 solid-state electrolytes, for example each of the x+1 membranes 13, a single anode 7′, a single cathode 10′ and two end plates 33, wherein the x pre-assembled modules 20 and the x+1 solid-state electrolytes, for example the x+1 membranes 13, are stacked alternately one above the other to form a stack of pre-assembled modules 3, wherein in the stack of pre-assembled modules 3 in each case one pre-assembled module 20 and the x+1 membranes 13 are stacked one above the other to form a stack of pre-assembled modules 3, wherein one pre-assembled module 20 and one solid-state electrolyte, for example a membrane 13, are alternately stacked one above the other in the stack of pre-assembled modules 3 and wherein one solid-state electrolyte, for example a membrane 13 is arranged on the top side and on the bottom side of the stack of pre-assembled modules 3 and one solid-state electrolyte, for example a membrane 13, is arranged between two adjacent pre-assembled modules 20, and wherein a single anode 7′ is arranged parallel to an outer solid-state electrolyte, for example a membrane 13 on one side of the stack of pre-assembled modules 3 and a single cathode 10′ is arranged parallel to an outer solid-state electrolyte, for example a membrane 13, on the other side of the stack of pre-assembled modules 3, wherein one end plate 33 is arranged parallel to the single anode 7′ and one end plate 33 is arranged parallel to the single cathode 10′ and the generated stack is compressed between the two end plates 33 to form a stack type device 23,

where x is an integer and ≥2.

In preferred embodiments of the stack type device 23 according to the invention, one or more, preferably each of the x+1 solid state electrolytes, for example each of the x+1 membranes 13 in the stack type device 23 has a thickness of less than 80 μm, preferably a thickness of less than 50 μm or less, particularly preferably a thickness of less than 20 μm or less, for example 15 μm or less, and wherein x is an integer and ≥2.

Depending on requirements, further components can be installed in the stack type device 23 at the appropriate locations, for example an insulating plate 32 can be installed between the solid-state electrolyte, for example membrane 13, and the end plate 33. Insulating plates 32 at these locations prevent, for example, the end plates 33 from being short-circuited, e.g. when screws are used. Corresponding components are known to the person skilled in the art. The skilled person can adapt the manufacturing method accordingly.

Another subject of the invention is a stack-type device 23 for operation under differential pressure for converting or generating high-pressure liquid or high-pressure gas, comprising x pre-assembled modules 20 according to the invention, x+1 solid-state electrolytes, for example membranes 13, a single anode 7, a single cathode 10′ and two end plates 33, wherein the x pre-assembled modules 20 and the x+1 solid-state electrolytes, for example membranes 13, are stacked alternately one above the other to form a stack of pre-assembled modules 3, wherein in the stack of pre-assembled modules 3 in each case one pre-assembled module 20 and one solid-state electrolyte, for example a membrane 13, are stacked alternately one above the other, and wherein a solid-state electrolyte, for example a membrane 13, is arranged on the upper side and the lower side of the stack of pre-assembled modules 3, and in each case one solid-state electrolyte, for example a membrane 13, is arranged between two adjacent pre-assembled modules 20, and wherein on one side of the stack of pre-assembled modules 3 a half-cell anode is arranged parallel to an outer solid-state electrolyte, for example a membrane 13, and on the other side of the stack of pre-assembled modules 3 a half-cell cathode is arranged parallel to an outer solid-state electrolyte, for example a membrane 13, wherein an end plate 33 is arranged parallel to the half-cell anode and parallel to the half-cell cathode and the stack produced is compressed between the two end plates 33 to form a stack type device 23,

where x is an integer and >2

A half-cell anode comprises only the anode side of an electrochemical cell 2, not the cathode side of the electrochemical cell 2. In preferred embodiments, a half-cell anode comprises a single anode 7′ and an anode frame 8. In preferred embodiments, a half-cell anode consists of a single anode 7′ and an anode frame 8. A half-cell anode completes an electrochemical cell 2 in a pre-assembled module 20 or a stack of pre-assembled modules 3.

A half-cell cathode comprises only the cathode side of an electrochemical cell 2, not the anode side of the electrochemical cell 2. In preferred embodiments, a half-cell cathode comprises a single cathode 10′ and a cathode frame 11. In preferred embodiments, a half-cell cathode consists of a single cathode 10′ and a cathode frame 8. A half-cell cathode completes an electrochemical cell 2 in a pre-assembled module 20 or a stack of pre-assembled modules 3.

In preferred embodiments, the stack type device 23 comprises at least 2 or 3 or 5 or more, for example 10, 50, 100, 500, 1000 or more pre-assembled modules 20 according to the invention. Preferably, in addition to a number of x pre-assembled modules 20 according to the invention, where x is an integer and >2, the stack type device 23 according to the invention comprises a cathode frame 11, a solid-state electrolyte, for example a membrane 13, an anode frame 8 and two end plates 33. Preferably, in stack type device 23 according to the invention, the first and the last electrochemical cell 2 are different from those that lie in between. For example, to produce a stack type device 23, a solid-state electrolyte, for example a membrane 13, is arranged on a cathode frame 11, x pre-assembled modules 20 and x solid-state electrolytes, for example membranes 13, are alternately stacked on the solid-state electrolyte, for example the membrane 13, and an anode frame 8 is stacked thereon. The stack is compressed between end plates 33 to form a stack type device 23, where x is an integer and ≥2.

In the stack type device 23, preferably one of the two end plates 33 is an upper end plate 38, which for example is arranged at the top in a stack type device 23. In the stack type device 23, preferably one of the two end plates 33 is a lower end plate 44, which is arranged at the bottom, for example in a stack type device 23.

A stack type device 23 is preferably operated as a flow reactor. Liquid and/or gas is continuously fed into the stack type device 23 and liquid and/or gas is continuously discharged from the stack type device 23. Liquid must be distributed from the connection for introduction of liquid (=liquid connection input) 39 of the stack type device 23 to the channels type I 14. At the same time, liquid must be routed from the channels type I 14 to the connection for discharging of liquid (=liquid connection outlet) 40. This requires space which may not be available on the end plate 33, for example because the end plate 33 then becomes too thick and if the end plate 33 becomes too thick, the stack type device 23 becomes too heavy.

Subject of the invention is a lid 37 for a stack type device 23 device. The lid 37 according to the invention has a construction in which as much space as possible is created for liquid without making the entire end plate 33 unnecessarily thick.

Subject of the invention is a lid 37 for a stack type device 23, wherein the end plate 33, for example the upper end plate 38, comprises at least one connection for introduction of liquid 39, at least one connection for discharge of liquid 40 and at least two distributor covers 41, wherein the upper end plate 38 to create space for liquid has at least two spaces for liquid distribution in the upper end plate 42, and wherein each of the at least two distributor covers 41 has space for liquid distribution in the distributor cover 43, and wherein at least one distributor cover 43 for the introduction of liquid into the stack type device 23 is connected to at least one connection for introduction of liquid 39, and a space for liquid distribution in the end plate 42, and wherein at least one further distributor cover 43 for the discharge of liquid from the stack type device 23 is connected to at least one connection for discharge of liquid 40 and a space for liquid distribution in the end plate 42.

Subject of the invention is a stack type device 23 which comprises the lid 37 according to the invention. The object of the invention is a stacking type 23 device according to the invention, which comprises the lid 37 according to the invention.

In order to completely seal the individual frames 1 of electrochemical cells 2 and the individual frames 1 of a stack type device 23, especially at high pressures or high differential pressures, the end plates 33 must be tensioned with a sufficient bolt force or contact pressure. The coating made of sealing material 22 then acts as a seal and completely seals the individual frames 1, anode frame 8 and cathode frame 11. If frames 1 with large frame surfaces are used, the contact pressure required to clamp the end plates 33 so that they are completely sealed is even higher. For frames 1 with a large frame area, if the core 21 of the anode frame and the core 21 of the cathode frame are completely coated with coating made of sealing material 22, the contact pressure is particularly high, i.e. with a large area of coating made of sealing material 22 on the first side of the frame 4 of the anode frame 8 and with a large first opening 6, i.e. with a long first side of the first opening 27 and possibly a long second side of the first opening 28. A large frame area means, for example, 1600 cm² or more. In preferred embodiments, not the entire frame surface of the anode frame 8 is necessary for the seal. In certain embodiments, not the entire frame surface of the cathode frame 11 is necessary for the seal. In order to reduce the contact pressure, the layer thickness of the coating made of sealing material 22 can be reduced in the areas of the surface of the core 21 that is not required for the seal. Corresponding anode frames 8 or cathode frames 11 comprise areas on the core 21 in which the coating made of sealing material 22 has a layer thickness and areas on the core 21 in which the coating made of sealing material 22″ has a reduced layer thickness compared to the layer thickness of the coating made of sealing material 22 (FIG. 10b, FIG. 14), e.g. the layer thickness of the coating made of sealing material 22″ in the area of the surface of the core 21 which is not required for sealing is 0.05 mm or more, for example 0.1 mm, preferably 0.2 mm or more less than the layer thickness of the coating made of sealing material 22 in the area of the surface of the core 21 which is required for sealing the active area (active area=first and second opening 6+9) and the channels type I and type II 14+15. In order to reduce the contact pressure, the thickness of the coating made of sealing material 22 can be reduced in the areas of the surface of the core 21 for the cathode frame 11 or the anode frame 8, which is not necessary for the seal, e.g. the area of the surface of the core 21 which is not required for sealing has a layer thickness of the coating made of sealing material 22″ reduced by 0.05 mm or more, for example 0.1 mm, preferably 0.2 mm or more, for example in the area of the surface of the core 21 which is not required for sealing the active area (first and second opening 6+9) and the channels type I and type II 14+15.

The area of the surface of the core 21 of the anode frame 8 and/or the cathode frame 11 in which the coating made of sealing material 22 is not reduced in thickness is primarily subjected to pressure when the stack type device 23 is clamped (FIG. 1, 10 to 15 MPa). The sealing area in which the coating made of sealing material 22 on the surface of the core 21 has a non-reduced layer thickness can be defined, for example, such that the area of the surface of the core 21 that is arranged at a distance of 0.2 mm or more, for example 0.5 mm or 1 mm or more, preferably 1.5 mm or 2 mm or more around the first inner opening 6 or the second inner opening 9 and around the channels type I 14 and the channels type II 15 (FIG. 10b, FIG. 14). The distance can vary. The distance to the first inner opening 6, the second inner opening 9, to the arrangement of the channels type I 14, to the channels type II 15, in which the coating made of sealing material 22 has a non-reduced layer thickness, can be the same or different. In particular embodiments, the coating made of sealing material 22 can have in the area of the surface or in parts of the area of the surface of the core 21 of the anode frame 8 or the cathode frame 11 in which the coating made of sealing material 22″ has a reduced layer thickness a layer thickness of zero, i.e. in particular embodiments in this area of the surface the core 21 is not coated with coating made of sealing material 22. By reducing the layer thickness of the coating made of sealing material 22″ in certain areas of the surface of the core 21 of the anode frame 8 or the cathode frame 11, the area that has to be compressed can be reduced for example by 50% in comparison to a coating made of sealing material 22 that coats the surface of the core 21 completely with the same layer thickness. This also reduces the contact pressure required to compress the frames 1 in the stack type device 23 by up to 50%.

Preferably, the stack type device 23 according to the invention is used for the electrolysis of liquid in the temperature range from 10 to 95 degrees Celsius, preferably in the temperature range from 40 to 80 degrees Celsius, particularly preferably at 68 to 72 degrees Celsius. The stack type device 23 according to the invention also has the advantage that the temperature difference from one side of the stack to the other side of the stack is preferably maximum 0 to 10 degrees Celsius, preferably maximum 3 to 7 degrees Celsius, in particular maximum 4 degrees Celsius.

A further advantage of advantageous embodiments of the invention are the manufacturing costs. In preferred embodiments, the channels type II 15 are not milled out of each anode frame 8 and each cathode frame 11 but are transferred once to a tool. A suitable tool is, for example, the negative for the anode frame 8, another tool is the negative for the cathode frame 11. For example, the arrangement of the channels type II 15, their diameter, their length and possibly other parameters are transferred to the tool. With the tool the channels type II 15 can be transferred into the sealing 22, for example as if they were stamped into the sealing material, preferably the rubber, for example EPDM, using a stamp. With the aid of the tool, the core 21 of the anode frame 8 or the core 21 of the cathode frame 11 is coated with the sealing 22 by vulcanization and at the same time desired structures are produced in the sealing 22, such as for example channels type II 15 on the first side of the frame 4 or the second side of the frame 5. For this method of manufacturing the frame 1, a preferably a sealing 22 made of rubber, for example EPDM, is used. In this embodiment, the core 21 is coated with sealing 22, whereby the channels type II 15 can be produced simultaneously in the desired areas of the anode frame 8 and/or the cathode frame 11 according to the invention. The moulded parts or rubber moulded parts produced by vulcanization of anode frame 8 and/or cathode frame 11 can be used directly and can be produced in large quantities at low cost. Alternative processes are known, for example injection molding or 3D printing.

The stack type device 23 is preferably designed in such a way that all components have a smooth and homogeneous surface so that no voltage peaks occur on the solid-state electrolyte, for example the membrane 13. In order to prevent at medium pressure, the solid-state electrolyte, for example the membrane 13 from being pressed or crawl 24 into the pores of the anode 7 and/or the cathode 10, for example anodes 7 and/or cathodes 10 with a pore diameter<0.1 mm are used.

The anode frame 8 and the cathode frame 11 can easily be joined together to form a pre-assembled module 20, since the sealing 22 and the anode frame 8 or the sealing 22 and the cathode frame 11 each consist of one component. Preferably, to produce a pre-assembled module 20 a BPP 16 connected to an anode 7, i.e. a BPP/anode 36 is used. For example, BPP 16 and anode 7 are welded together so that BPP 16 and anode 7 are present as one component BPP/anode 36. To produce the pre-assembled module 20, the anode frame 8 is first inserted or pressed onto the anode 7 or the anode 7 of the BPP/anode 36. For example, in addition to a first pin 19 as a means for connection to the cathode frame 11, the anode frame 8 can also have a second pin 19 as a means for connection to the BPP 16 or the BPP/anode 36, which can be inserted into the BPP 16. For this purpose, the BPP 16 or the BPP 16 of the BPP/anode 36 comprises a corresponding means for connection to the anode frame 8, preferably a hole 18. The anode frame 8 with the inserted or pressed-in anode 7 and the BPP 16 or the BPP/anode 36 is then turned over and the cathode frame 11 can also be inserted on the other side of the anode frame 8 with means for connection to the anode frame, preferably a hole 18, and connected to the anode frame 8. The cathode 10 is then inserted or pressed into the cathode frame 11 (FIG. 6). A pre-assembled module 20 is obtained. Pre-assembled modules 20 can then be stacked alternately with solid-state electrolytes, for example membranes 13, for example via centring pins in order to manufacture stacks of pre-assembled modules 3 or stack type devices 23.

### LIST OF REFERENCE SIGNS

| | |
|---|---|
| Frame | 1 |
| Electrochemical cell | 2 |
| Stack of pre-assembled modules 20 | 3 |
| First side of frame 1 | 4 |
| The side opposite the first side of the frame 4 of the anode frame 8 | 4″ |
| Second side of frame 1 | 5 |
| The side opposite the second side of the frame 5 of the cathode | 5″ |
| frame 11 | |
| First opening | 6 |
| Anode | 7 |
| Single anode | 7′ |
| Anode frame | 8 |
| Second opening | 9 |
| Cathode | 10 |
| Single cathode | 10′ |
| Cathode frame | 11 |
| Step | 12 |
| Membrane | 13 |
| Channel type I | 14 |
| Channel type II | 15 |
| Bipolar plate (BPP) | 16 |
| Gap | 17 |
| Hole | 18 |
| Pen | 19 |
| Pre-assembled module | 20 |
| Core | 21 |
| Coating made of sealing material | 22 |
| Reduced layer thickness of the coating made of sealing material 22 | 22″ |
| Stack type device | 23 |
| Crawl | 24 |
| Rubber lip | 25 |
| Elevation between two channels type II 15 | 26 |
| Circumferential elevation 26 to increase the sealing | 26″ |
| effect around the active area | |
| First side of the first opening 6 of the anode frame 8 | 27 |
| First side of the second opening 9 of the cathode frame 11 | 27′ |
| Second side of the first opening 6 of the anode frame 8 | 28 |
| Second side of the second opening 9 of the cathode frame 11 | 28′ |
| Third side of the first opening 6 of the anode frame 8 | 29 |
| Third side of the second opening 9 of the cathode frame 11 | 29′ |
| Fourth side of the first opening 6 of the anode frame 8 | 30 |
| Fourth side of the second opening 9 of the cathode frame 11 | 30′ |
| Edge of channel type I 14 | 31 |
| Insulating panel | 32 |
| End plate | 33 |
| Tie rod | 34 |
| Current collector plate | 35 |
| BPP 16 and anode 7 are connected (=BPP/anode) | 36 |
| Lid for a stack type device 23 | 37 |
| Upper end plate | 38 |
| Connection for introduction of liquid (=liquid connection input) | 39 |
| Connection for discharge of liquid (=liquid connection outlet) | 40 |
| Distributor cover | 41 |
| Space for liquid distribution in the upper end plate 38 | 42 |
| Space for liquid distribution in the distributor cover | 43 |
| Lower end plate | 44 |

### DESCRIPTION OF THE FIGURES

FIG. 1: Classical structure of an electrochemical cell with frame 1 from the state of the art, solid-state electrolyte, for example membrane 13, bipolar plate (BPP) 16, anode 7, cathode 10 with gap 17 between frame 1 and anode 7 and frame 1 and cathode 10. The frame 1 shown here comprises channels type I 14 for the supply and removal of water and gas.

FIG. 2: Frame 1 according to FIG. 1 with deformation of frame 1 and formation of a larger gap 17 between frame 1 and anode 7 and frame 1 and cathode 10 and crawl 24 of the solid-state electrolyte, for example membrane 13, into the enlarged gap 17 between frame 1 and anode 7 and frame 1 and cathode 10.

FIG. 3a: Shown is a part of the frame 1 according to the invention, which comprises a core 21 coated with a coating made of sealing material 22 and which comprises a channel type II 15 in the coating made of sealing material 22.

FIG. 3b: A part of the frame 1 according to the invention is shown. The frame 1 comprises that a core 21 coated with a coating made of sealing material 22 and a part of a channel type II 15 in the coating made of sealing material 22.

FIG. 4: The cathode frame 11 according to the invention shown here has a second opening 9, which is framed by a first side 27′, a second side 28′, a third side 29′ and a fourth side 30′ of the cathode frame 11. The cathode frame 11 comprises two holes 18 as a connecting element for connection to the anode frame 8 and twenty channels type I 14. The cathode frame 11 comprises a several channels type II 15 on the second side 5, which connect the second opening 9 with ten channels type I 14, each channel type I 14 being connected to the second opening 9 by means of a several of channels type II 15. On the side opposite the second side 5 of the cathode frame 5″, there are no channels type II 15 that connect the channels type I 14 with the second opening 9.

FIG. 5: The anode frame 8 according to the invention shown here has a first opening 6, which is framed by a first side 27, a second side 28, a third side 29 and a fourth side 30 of the anode frame 8. The anode frame 8 comprises two pins 19 as a connecting element for connection to the cathode frame 11 and, in this specific example, also twenty channels type I 14 which are arranged such that, when the anode frame 8 and the cathode frame 11 are connected, they can interact with the twenty channels type I 14 of the cathode frame 11 for the supply and removal of liquid and gas. The anode frame 8 comprises channels type II 15 on the first side 4, which connect the first opening 6 with ten channels type I 14. On the side opposite the first side of the frame 4 of the anode frame 4″, there are no channels type II 15 which connect the channels the type I 14 with the first opening 6. The anode frame 8 comprises a coating made of sealing material 22, preferably rubber. This anode frame 8 comprises a lip made of sealing material, preferably a rubber lip 25.

FIG. 6: schematically shows the method for manufacturing a pre-assembled module 20 with the method steps a) initial position: anode 7 and BPP 16 are connected (BPP/anode 36), b) 1st step: the pins 19 of the anode frame 8 are inserted into the holes 18 of the BPP/anode 36, c) 2nd step: turning over the arrangement from b), the BPP 16 side of the BPP/anode 36 can be seen; d) 3rd step: the cathode frame 11 is inserted into the arrangement, e) 4th step: the cathode 10 is inserted into the second opening 9.

FIG. 7: shows an exploded view of a pre-assembled module 20. The parts that are comprised in the pre-assembled module 20 can be seen: Cathode frame 11, anode frame 8, BPP/anode 36, cathode 10 and the arrangement of cathode frame 11, anode frame 8, BPP/anode 36, and cathode 10 in the pre-assembled module 20. A sequence in which the individual parts are preferably assembled is also shown. The channels type II 15 in the cathode frame 11 are arranged on the side opposite the visible side of the cathode frame 11. This is the second side of the frame 5. They are not visible from this perspective. Their arrangement on the second side of the frame 5 is marked in light grey on the side opposite the second side of the frame of the cathode frame 5″.

FIG. 7a: shows a pre-assembled module 20 in plan view. The four parts belonging to the pre-assembled module 20 can be seen: Cathode frame 11, anode frame 8, BPP/anode 36 and cathode 10. The channels type II 15 are all arranged in the direction towards the BPP/anode 36 and are therefore not visible in the pre-assembled component 20, because they are arranged inside the pre-assembled component 20. The arrangement of the channels type II 15 inside the module 20 is shown in light grey on the visible side of the cathode frame 11 (=the side opposite the second side of the frame of the cathode frame=5″).

FIG. 7b shows a side view of a pre-assembled module 20. Anode frame 8 and cathode frame 11 are connected. The anode 7 is inserted into the anode frame 8 and the cathode 10 is inserted into the cathode frame 11. The BPP 16 is located between anode frame 8 and cathode frame 11. Anode frame 8 and cathode frame 11 form a step 12 because the first opening 6 is larger than the second opening 9. The BPP 16 is arranged on the cathode 10, the step 12 and the cathode frame 11 and rests with its other side on the anode 7 and the anode frame 8.

FIG. 7c: shows an enlarged section of a part of the pre-assembled module 20 from FIG. 7b, which clearly shows the step 12.

FIG. 8: Shown is a section of a schematic structure of a stack type device 23 according to the invention, namely a stack of pre-assembled modules 3. This arrangement shows a stack with three electrochemical cells 2. The arrows show the direction of the gas pressure during high-pressure liquid electrolysis, which is carried out under a differential pressure of 40 bar.

FIG. 8a: Enlarged section of a part of an electrochemical cell 2 with the step 12. The arrows indicate the direction from which the increased pressure acts on the solid-state electrolyte, for example the membrane 13, at differential pressure.

FIG. 9a: Exemplary dimensions for a cathode frame 11. The channels type II 15 connect the second opening 9 with the channels type I 14, which are arranged along the second side of the second opening 28′ and along the fourth side of the second opening 30′. In each case, several channels type II 15 connect the second opening 9 with a channel type I 14. The individual channels type II 15 are separated from one another by elevations 26.

FIG. 9b: Exemplary dimensions for an anode frame 8 matching the cathode frame 11 shown in FIG. 9a. The channels type II 15 connect the first opening 6 with the channels type I 14, which are arranged along the first side of the first opening 27 and along the third side of the first opening 29. In each case, several channels type II 15 connect the first opening 6 with a channel type I 14. The individual channels type II 15 are separated from one another by elevations 26.

FIG. 10a: Shown is an embodiment of an anode frame 8. The anode frame 8 comprises channels type I 14 and channels type II 15, wherein the channels type II 14 are arranged in a fan shape on the first side of the frame 4. In this embodiment, the anode frame 8 is quadrangular and comprises a quadrangular first opening 6 and twenty channels type I 14, wherein five of the channels type I 14 are arranged in each of the four sides of the anode frame, i.e. the first side of the first opening 27 comprises five channels type I 14, the second side of the first opening 28 comprises five channels type I 14, the third side of the first opening 29 comprises five channels type I 14 and the fourth side of the first opening 30 comprises five channels type I 14. In two opposite sides of the anode frame 8, the five channels type II 14 are each connected to eight channels type II 15. Each channels type II 15 is connected to a channels type I 14 and to the first opening 6. The channels type II 15 are arranged in a fan shape on the first side of the frame 4 and are evenly spaced along the first side of the first opening 27 and the third side of the first opening 29.

FIG. 10b: An anode frame 8 is shown. The anode frame 8 comprises channels type I 14, wherein a part of the channels type I 14 has a round shape and a part of the channels type I 14 has an oval shape. The anode frame 8 comprises a coating made of sealing material 22 arranged on the core 21 (the core is not shown) of the anode frame 8. The coating made of sealing material 22 has a defined layer thickness, which is shown as a bordered area. The line surrounding the outlined area is a circumferential elevation 26 to increase the sealing effect around the active area 26″. The area of the anode frame 8 surrounding the channels type I 14 and the channels type II 15 and the first opening 6 is coated with coating made of sealing material 22 in the defined layer thickness. The remaining part of the core 21 of the anode frame 6 (shown outside the border and labelled 22′) has a reduced thickness of the coating made of sealing material 22″ compared to the defined thickness of the coating made of sealing material 22.

FIG. 10c: The anode frame 8 is shown in an oblique side view. This shows the channels type II 15, which are designed as depressions in the coating made of sealing material 22, which has a defined layer thickness in this area of the anode frame 8. Individual adjacent channels of type II 15 are separated by elevations (=area with a coating made of sealing material 22 with a defined layer thickness).

FIG. 10d shows a section of the anode frame 8 from FIG. 10c.

FIG. 10e: A cathode frame 11 is shown. The cathode frame 11 comprises channels type I 14, some of the channels type I 14 having a round shape and some of the channels type I 14 having an oval shape. The oval channels type I 14 are connected to the second opening 9 via channels type II 15. The cathode frame 11 comprises a rubber lip 25 for isolating the single voltage measurement. An anode frame 8 could have an analogous arrangement.

FIG. 11 shows an embodiment of a pre-assembled module 20 (shown without cathode 10 and without solid-state electrolyte, for example without membrane 13) comprising cathode frame 11 and anode frame 8. The step 12 is formed by the different size of the first opening 6 and the second opening 9. On a part of the step 12 channels type II 15 are arranged, which are only partially visible because they are covered by the cathode frame 11.

FIG. 12 shows a stack type device 23 according to the invention with stacks of electrochemical cells 2, insulating plates 32, end plates 33, tie rods 34 and current collector plate 35.

FIG. 13 shows a preferred embodiment of the anode 7, where the BPP 16 is connected to the anode 7 to form a BPP/anode 36.

FIG. 14 shows the pressure distribution in an electrochemical cell 2 with an anode frame 8 as shown in FIG. 10b. The highest pressure of 10 to 15 MPa is in the region of the anode frame 8 in which the core 21 is coated with coating made of sealing material 22 in a defined layer thickness, i.e., for example, along the first side of the first opening 27 and along the second side of the first opening 29 and in the region around the channels type I 14. Excluded from this is the area in which the channels type II 15, which connect the first opening 6 with the channels type I 14, and the elevations 26 are arranged. In this area, the pressure is only 1 to 2 MPa. An even lower pressure of 0.1 to 0.5 MPa has the area at the outer edge of the anode frame 8, where the core 21 is coated in comparison to the coating made of sealing material 22 of defined layer thickness with a reduced layer thickness (=coating made of sealing material 22″ with reduced layer thickness), has.

FIG. 15a shows the lid 37 according to the invention for a stack type device 23. The lid 37 comprises an end plate 33, for example an upper end plate 38, which is connected to two distributor covers 41, wherein one distributor cover 41 comprises a connection for introduction of liquid 39 and another distributor cover 41 comprises a connection for discharge of liquid 40.

FIG. 15b shows the lid 37 for a stack type device 23 with a distributor cover 41 removed so that the space for distribution of liquid in the end plate 42 and the channels type I 14 connected to the space for distribution of liquid in the end plate 42 are visible in the end plate 33.

FIG. 15c shows a distributor cover 41 for the lid 37 according to the invention for a stack type device 23, whereby the space for water distribution in the distributor cover 43 is visible.

FIG. 15d shows a diagram with a simulation of how, for example, water is distributed in the lid 37 according to the invention. The diagram also shows the different flow velocities at different points of the lid 37 and in the area of the transition to the channels type I 14.

FIG. 16 shows an anode frame 7 with arrangement of channels type I 14 and type II 15 as well as areas with coating made of sealing material 22 and areas with coating made of sealing material 22″ with reduced layer thickness. The channels type II 15 connect a part of the channels type I 14 with the first opening 6. They are arranged along the first side of the first opening 27 and along the third side of the first opening 29 at regular intervals, so that each channel type II 15 introduces water or discharges water and gas into the same area of the first opening 6 or the active area.

FIG. 16a to c show enlarged sections of the anode frame from FIG. 16.

FIG. 17 shows a cathode frame 11 with arrangement of channels type I 14 and type II 15 as well as areas with coating made of sealing material 22 and areas with coating made of sealing material 22″ with reduced layer thickness. The channels type II 15 connect a part of the channels type I 14 with the second opening 9. They are arranged along the second side of the second opening 28′ and along the fourth side of the second opening 30′ at regular intervals, so that each channel type II 15 introduces water or discharges water and gas into the same area of the first opening 6 or the active area.

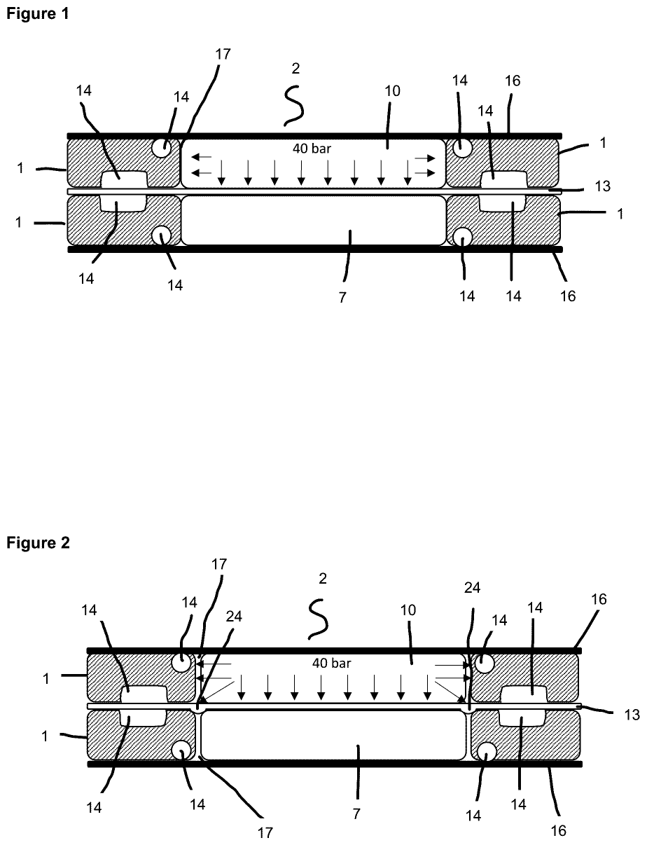

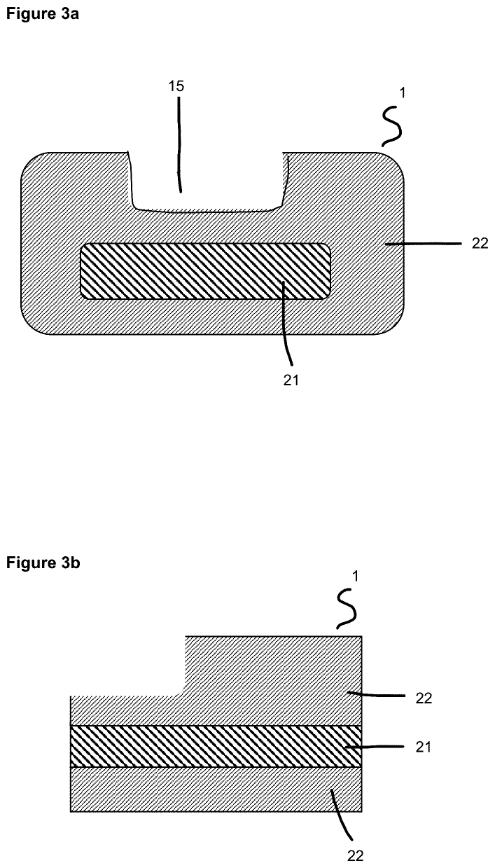

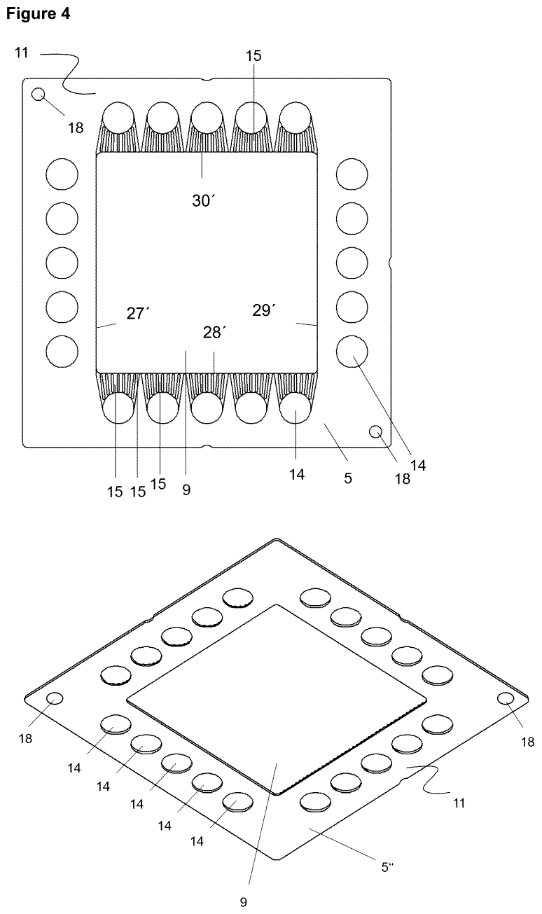

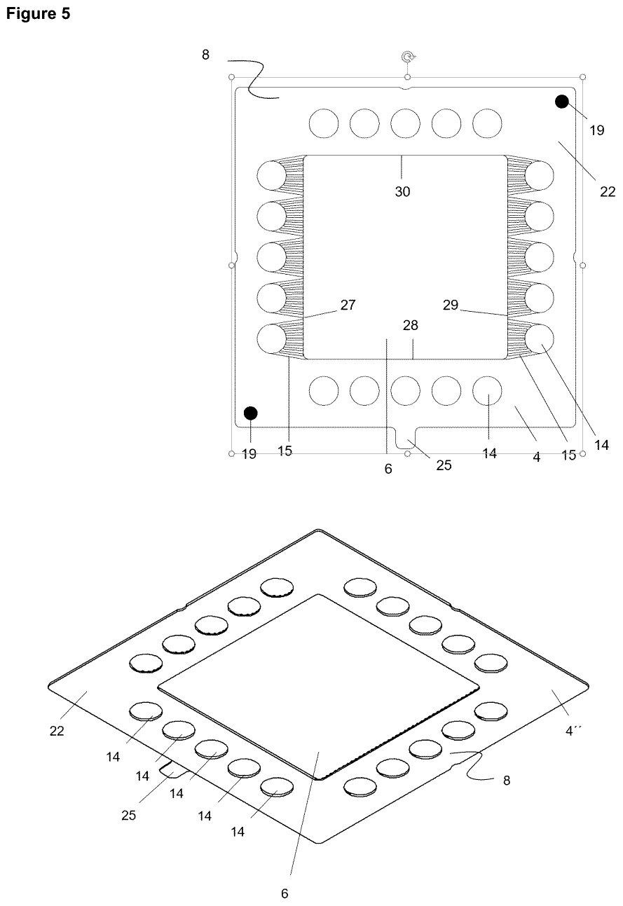

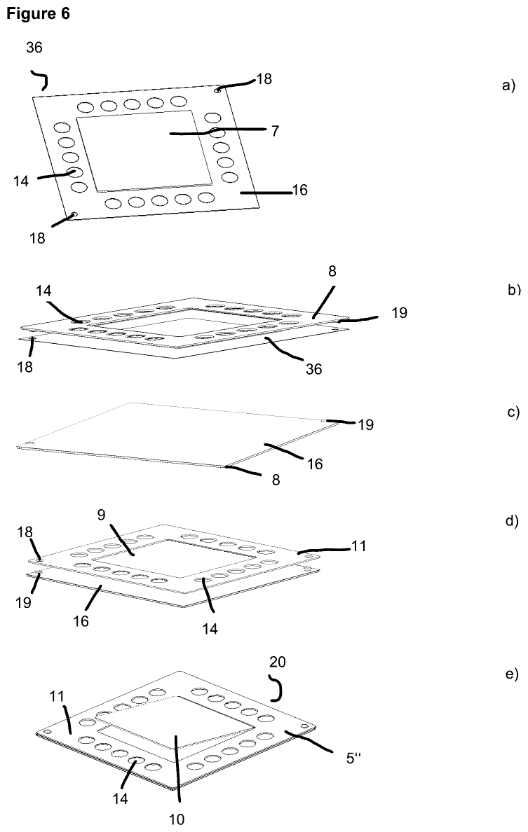

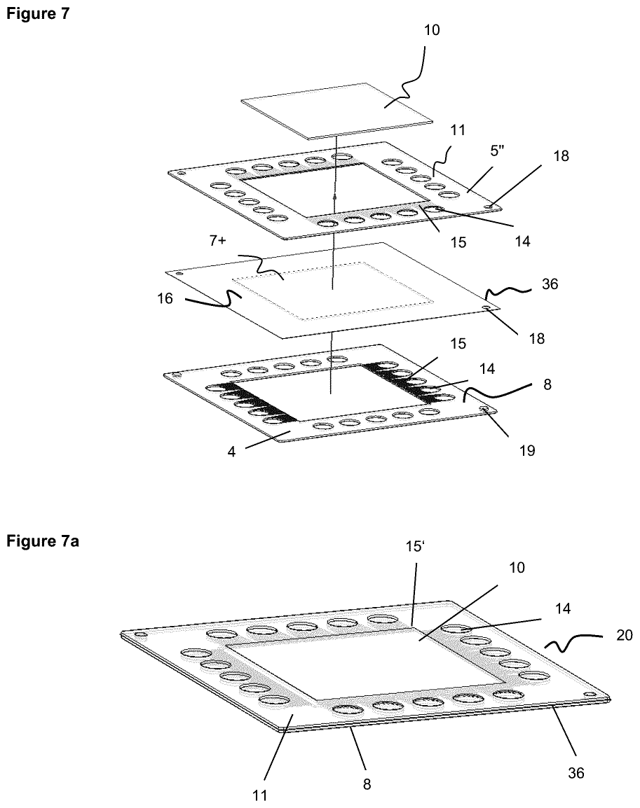

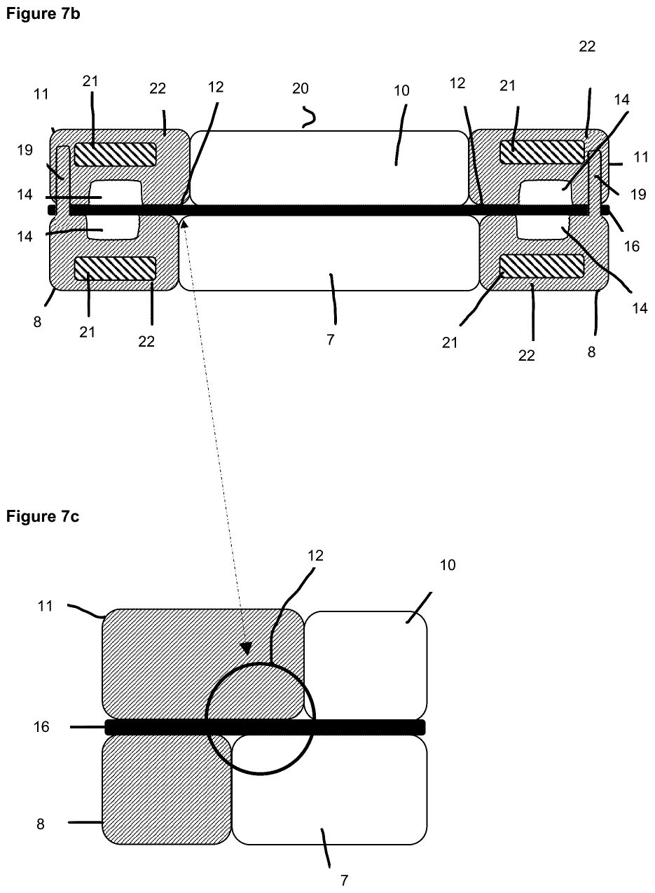

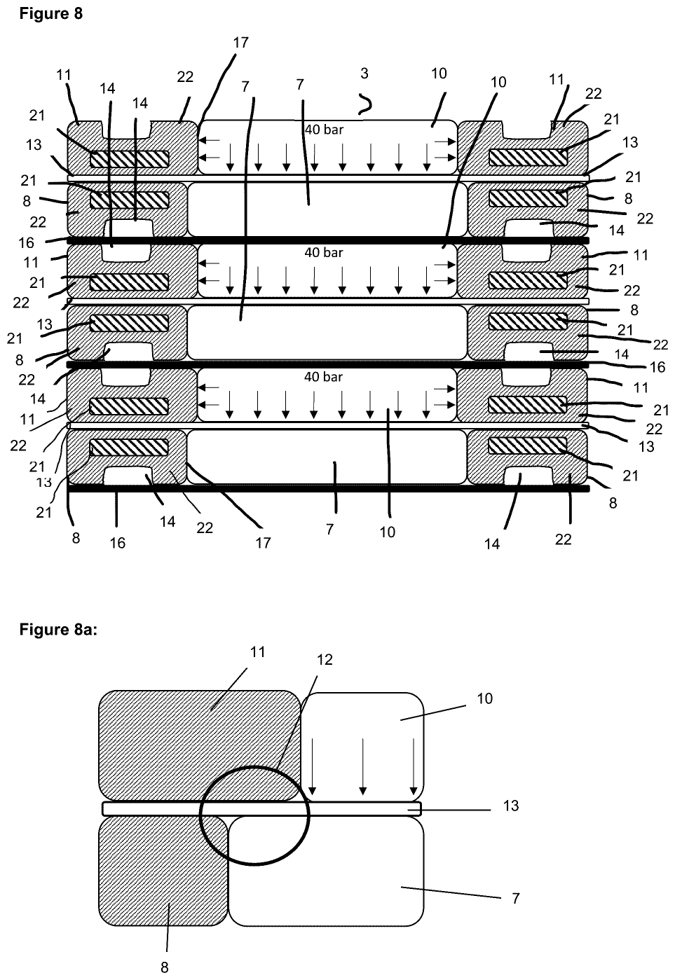

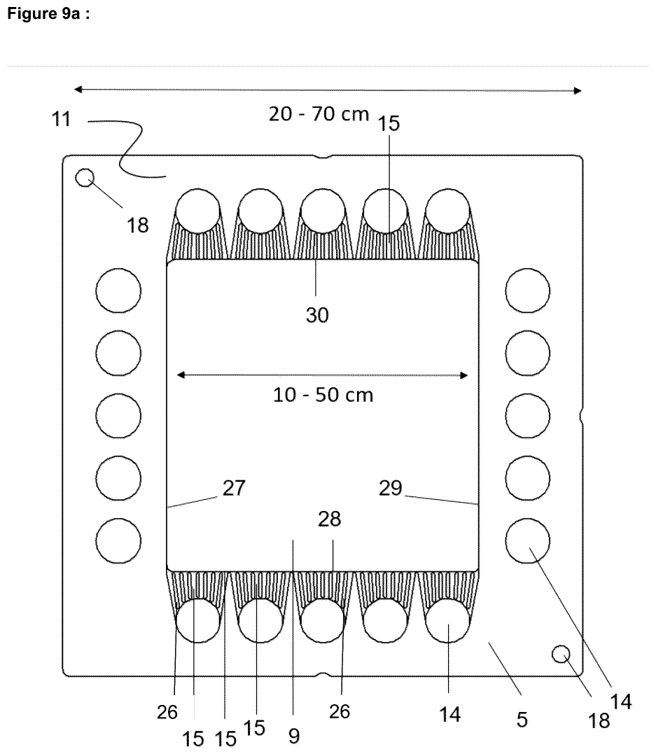

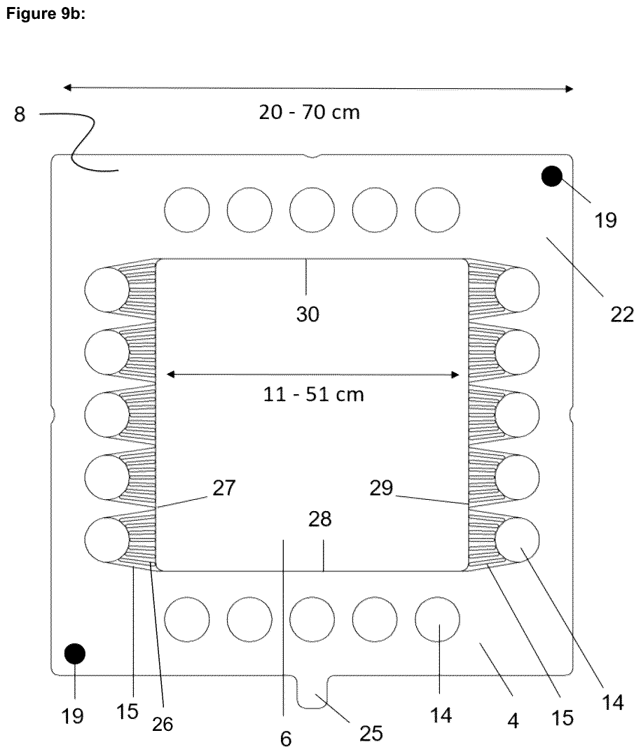

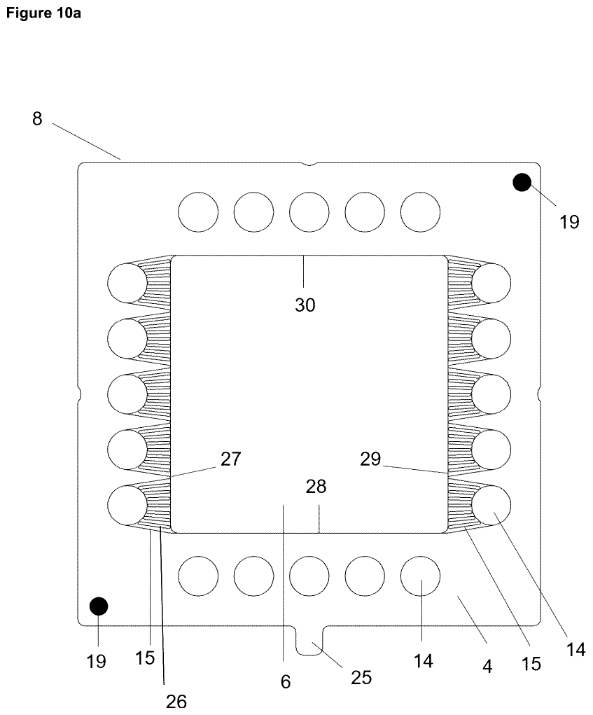

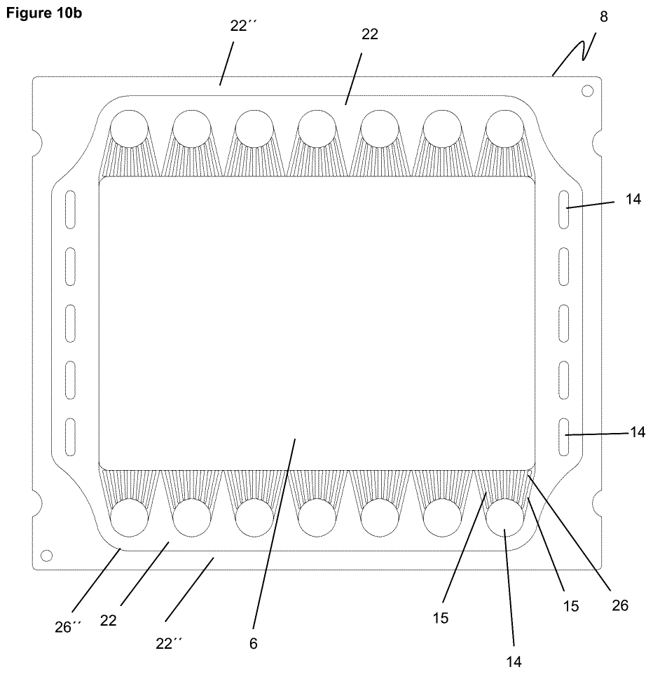

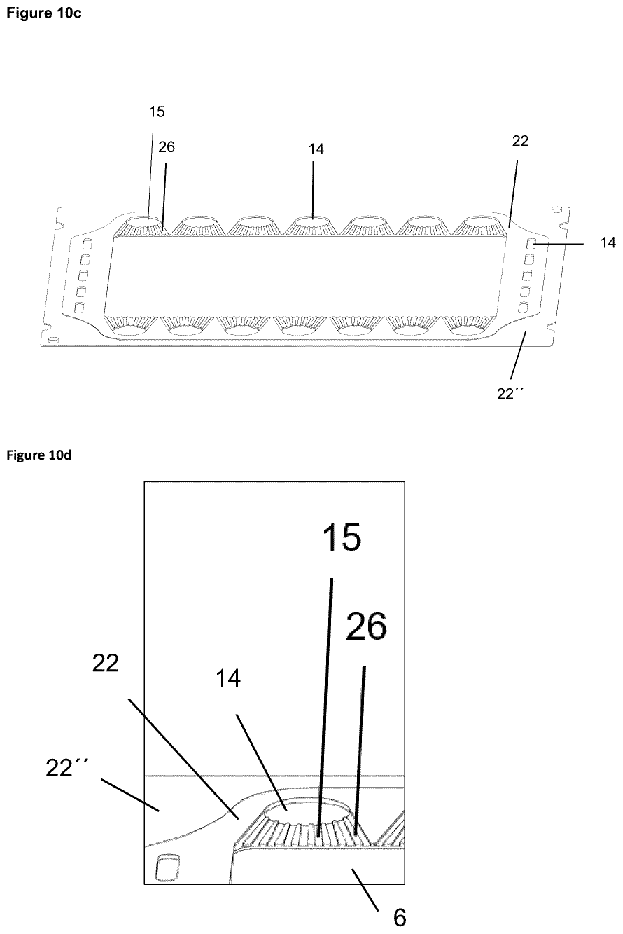

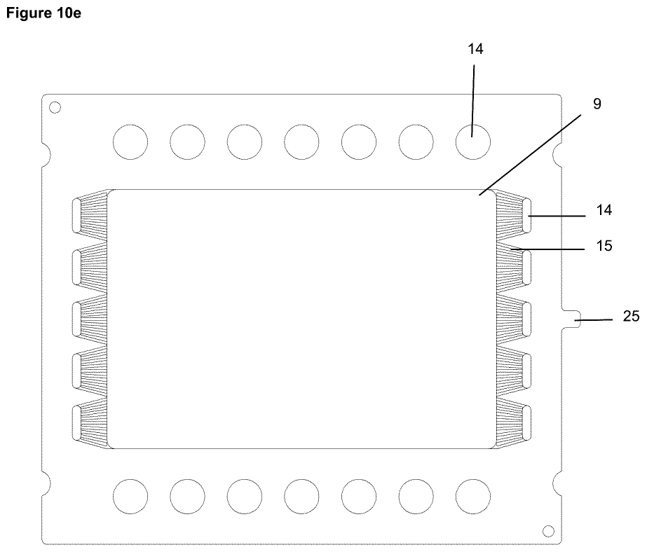

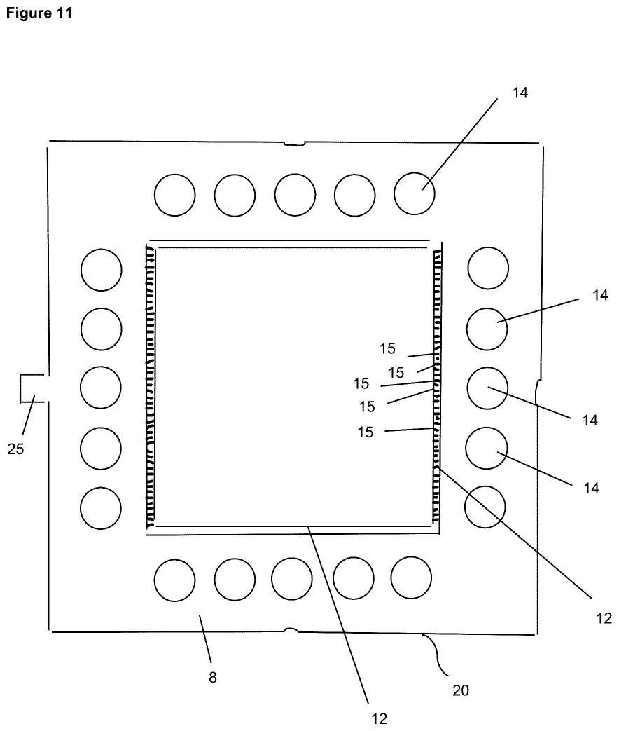

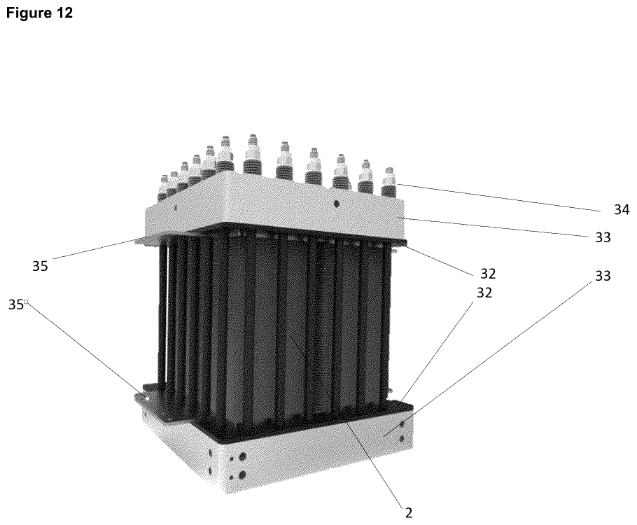

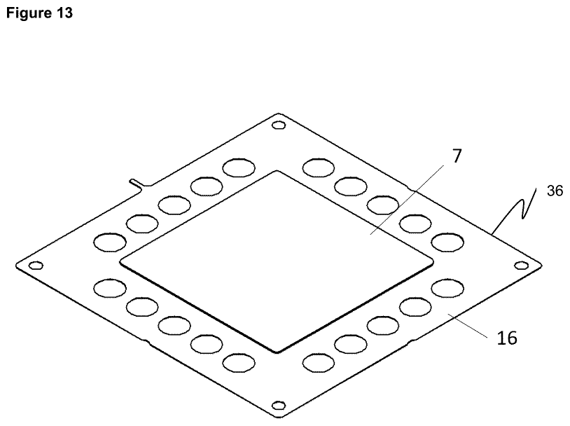

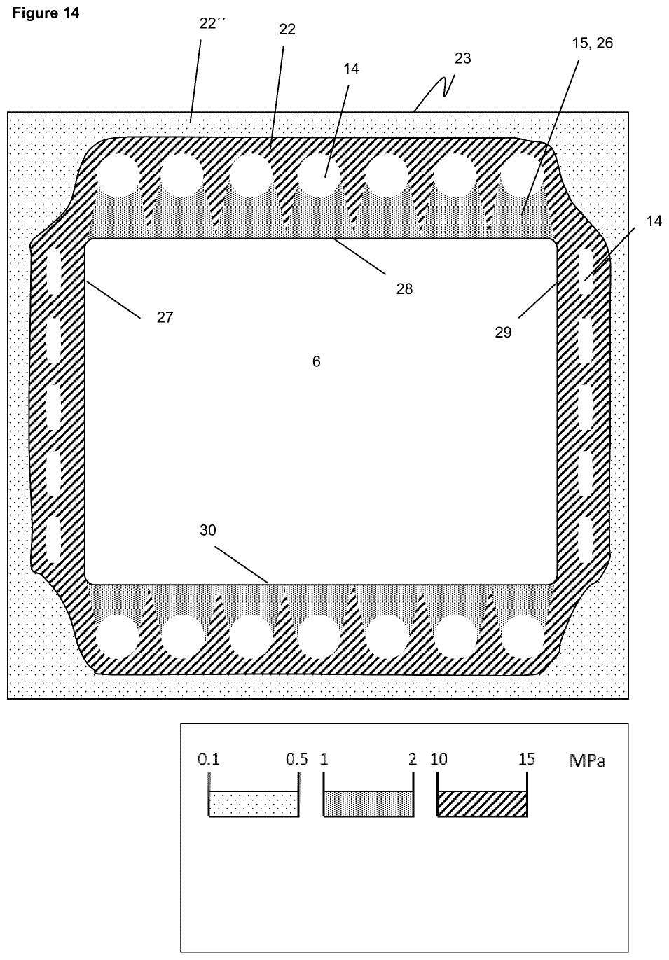

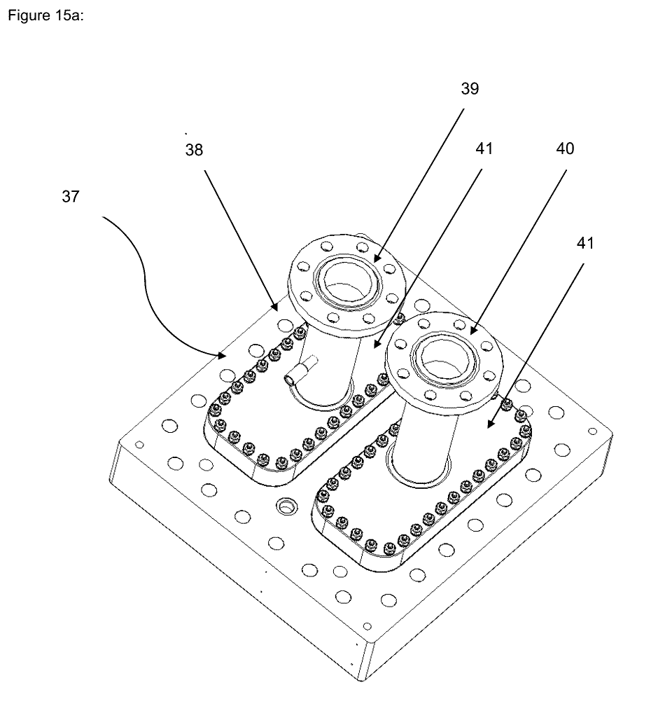

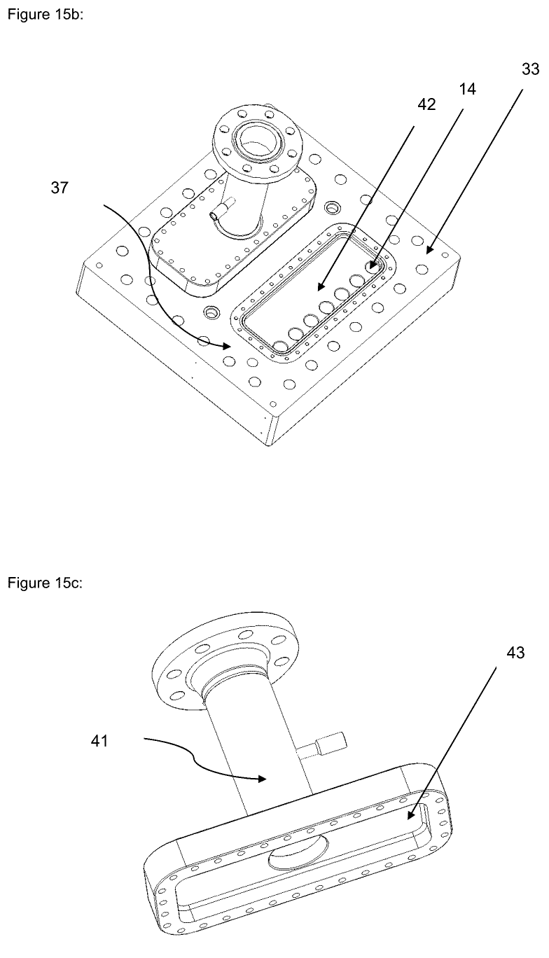

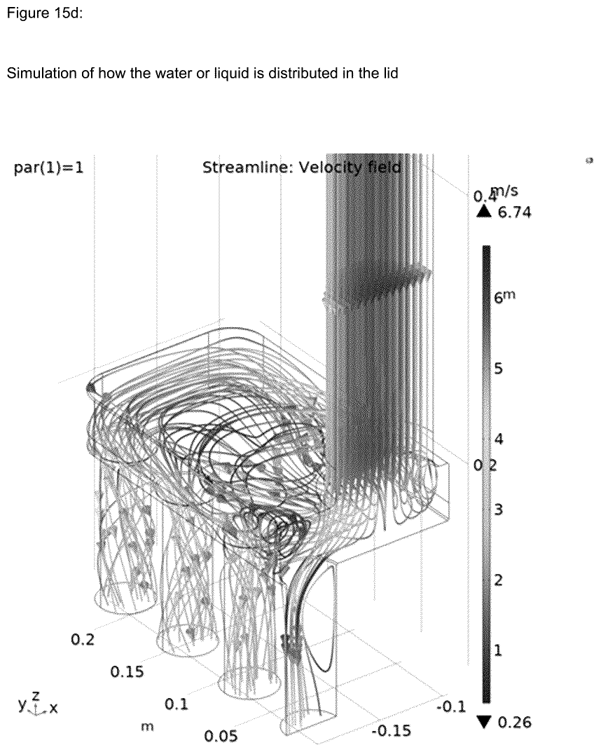

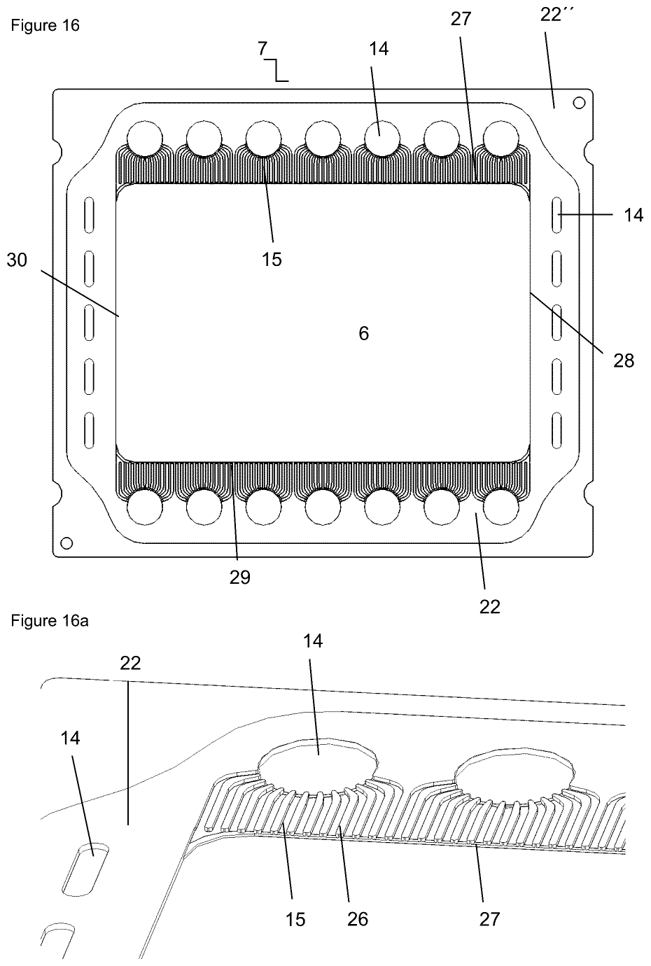

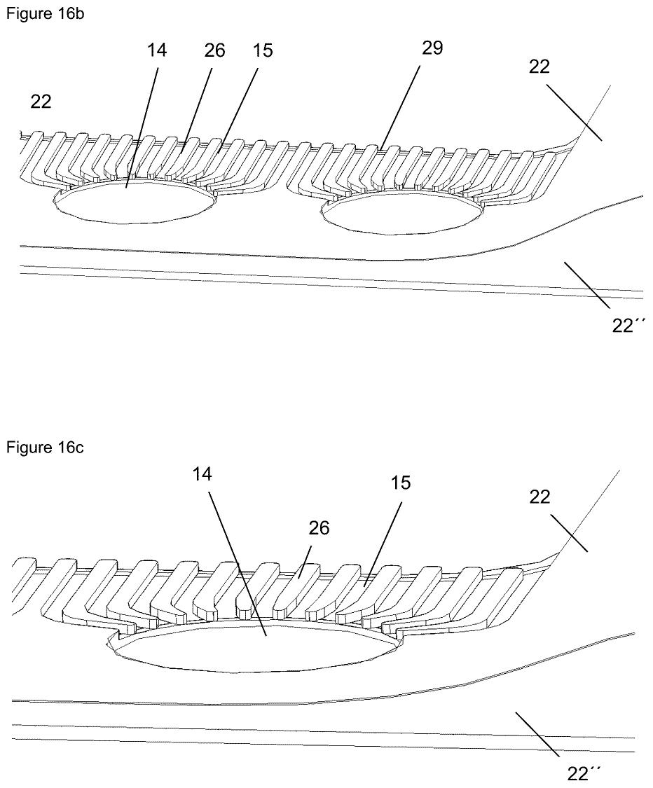

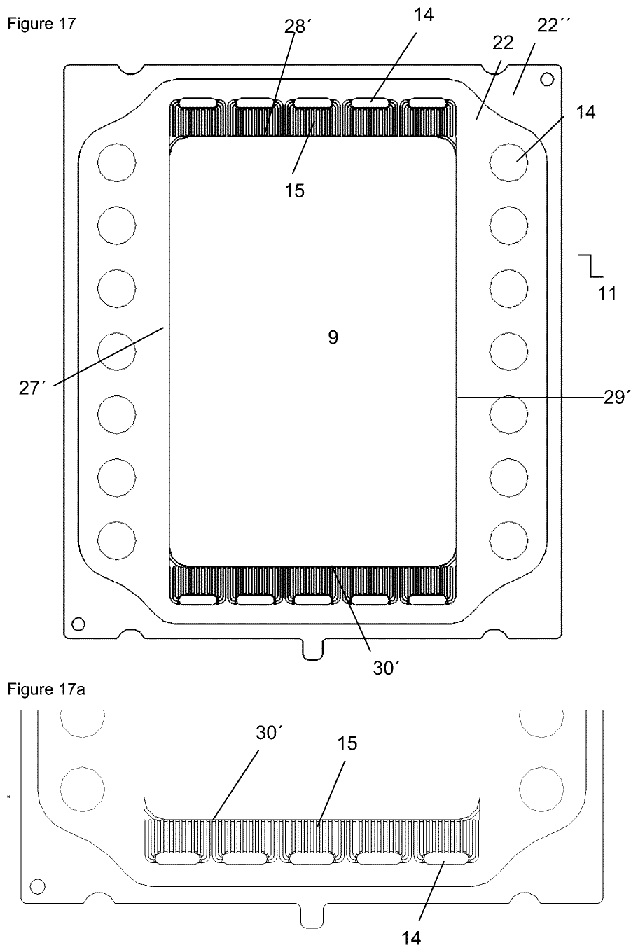

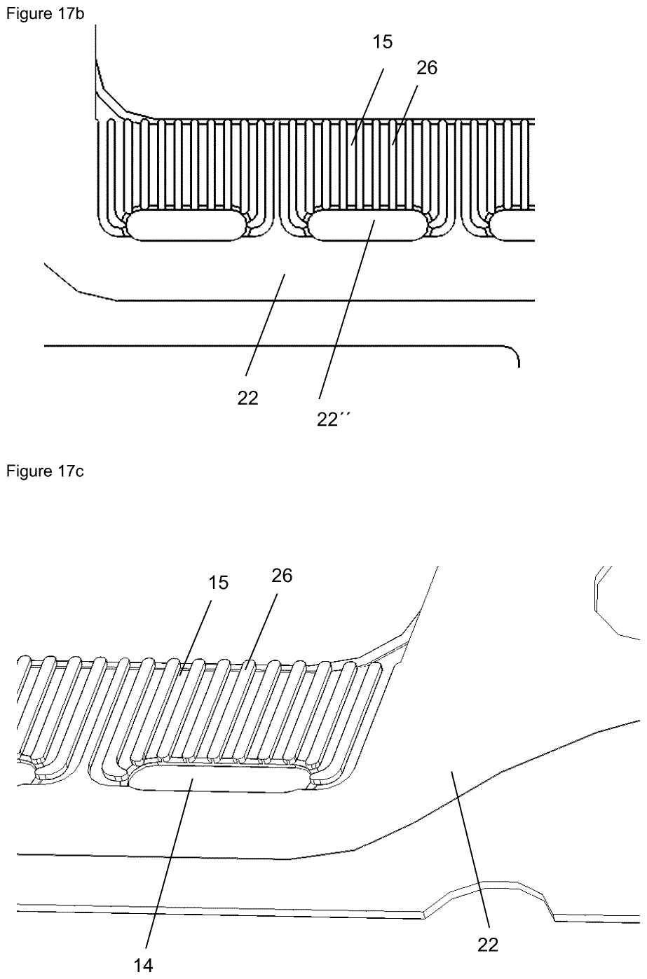

1. A frame for an electrochemical cell for a stack type device, the frame comprising a first side of the frame having a planar first surface and a second side of the frame opposite the first side having a planar second surface, and an anode frame and a cathode frame, and
wherein the anode frame comprises the first side of the frame, a side opposite the first side of the frame of the anode frame and a first opening for receiving the anode, wherein the first opening extends from the first side of the frame to the opposite side of the anode frame,
wherein the cathode frame comprises the second side of the frame, a side opposite the second side of the frame of the cathode frame and a second opening for receiving the cathode, wherein the second opening extends from the second side of the frame to the opposite side of the cathode frame,
wherein the side opposite the first side of the frame of the anode frame and the side opposite the second side of the frame of the cathode frame are arranged next to each other,
wherein the anode frame and cathode frame are connected to each other,
wherein the first opening and the second opening are connected to each other, characterized in that the first opening is larger than the second opening and wherein the anode frame and the cathode frame are arranged in such a way that the side opposite the first side of the frame of the anode frame and the side opposite the second side of the frame of the cathode frame form a step at the transition from the anode frame to the cathode frame, and wherein the step forms a planar third surface as a support surface for a solid-state electrolyte and wherein the anode frame comprises a core and a coating made of sealing material and wherein the cathode frame comprises a core and a coating made of sealing material.

2. The frame according to claim 1 comprising one or more channels type I for the transport of liquid and gas into and out and comprising one or more channels type II for the transport of liquid and gas into and out, wherein the channels type I are not connected to the first opening in the anode frame or the second opening in the cathode frame and wherein channels type II connect channels type I with the first opening and the second opening, characterized in that the anode frame comprises one or more channels type II on the surface of the first side of the frame, which are connected to one or more channels type I and connect the one or more channels type I with the first opening and which, when the frame is installed in an electrochemical cell or a stack type device, are arranged in the direction of the bipolar plate (BPP), and wherein the side opposite the first side of the frame of the anode frame comprises no channels type II.

3. The frame according to claim 2 comprising one or more channels type I for the transport of liquid and gas into and out and comprising one or more channels type II for the transport of liquid and gas into and out, wherein channels type I are not connected to the first opening in the anode frame or the second opening in the cathode frame and wherein channels type II connect channels type I with the second opening and the first opening, characterized in that the cathode frame comprises on the surface of the second side of the frame one or more channels type II which are connected to one or more channels type I and connect the channel(s) type I to the second opening and which, when the frame is installed in an electrochemical cell or a stack type device, are arranged in the direction of the bipolar plate (BPP), and wherein the side opposite the second side of the frame of the cathode frame comprises no channels type II.

4. The frame according to one of claim 2, wherein the first opening is formed by a first side, a second side, a third side and a fourth side, and wherein for uniform flow of liquid through the first opening and for constant removal of the reaction heat from the first opening each channel type I, which is connected to the first opening, is connected to the first opening by means of at least two channels type II, and
the channels type II are arranged next to each other on the first side of the frame, and the distance between two adjacent channels type II on the first side of the first opening is ≤3 mm and the distance between two adjacent channels type II on the third side of the first opening is ≤3 mm.

5. The frame according to claim 4, wherein the second opening is formed by a first side, a second side, a third side and a fourth side, and wherein, for uniform flow of water through the second opening and for constant removal of the reaction heat from the second opening, each channel type I connected to the second opening is connected to the second opening by means of at least two channels type II and
the channels type II are arranged next to one another on the second side of the frame, and the distance between two adjacent channels type II on the second side of the second opening is ≤3 mm and the distance between two adjacent channels type II on the fourth side of the second opening is ≤3 mm.

6. The frame according to and claim 5, wherein the distance between adjacent channels type II on the first side of the first opening and on the third side of the first opening is equal, and wherein optionally the distance between adjacent channels type II on the second side of the second opening and on the fourth side of the second opening is equal.

7. The frame according to claim 6, wherein the at least two channels type II are arranged in a fan-shaped manner between the first side of the first opening and the channel type I which is connected to the first opening by means of said at least two channels type II, and wherein the at least two channels type II are arranged in a fan-shaped manner between the third side of the first opening and the channel type I which is connected to the first opening by means of said at least two channels type II, and wherein optionally the at least two channels type II between the second side of the second opening and the channel type I, which is connected to the second opening by means of these at least two channels type II, are arranged in a fan-shaped manner and the at least two channels type II between the fourth side of the second opening and the channel type I, which is connected to the second opening by means of these at least two channels type II, are arranged in a fan-shaped manner.

8. The frame according to claim 1, wherein the core of the anode frame is made of metal and the core of the cathode frame is made of metal, and wherein the coating made of sealing material that the anode frame comprises is a coating made of rubber, and wherein the coating made of sealing material that the cathode frame comprises is a coating made of rubber.

9. The frame according to claim 1, wherein a part of the coating made of sealing material of the anode frame in order to reduce the contact pressure has a reduced layer thickness of the coating made of sealing material in comparison to the layer thickness of the coating made of sealing material of the anode frame, and/or a part of the coating made of sealing material of the cathode frame in order to reduce the contact pressure has a reduced layer thickness of the coating made of sealing material in comparison to the layer thickness of the coating made of sealing material of the cathode frame.

10. The frame according to claim 9, wherein the coating made of sealing material in a part of the anode frame has a circumferential elevation in order to increase the sealing effect, which surrounds the first opening and/or wherein the coating made of sealing material in a part of the cathode frame has a circumferential elevation in order to increase the sealing effect, which surrounds the second opening.

11. The Frame according to claim 1, wherein the anode frame comprises one or more connecting elements for connection to the cathode frame and the cathode frame comprises one or more connecting elements for connection to the anode frame wherein the connecting elements are arranged such that the anode frame and the cathode frame can be connected to each other and the hole(s) are arranged in such a way that the hole or holes in the cathode frame are plugged onto the pin or pins in the anode frame and the anode frame and cathode frame can thereby be connected to one another.

12. An electrochemical cell for operation under differential pressure of up to 40 bar and for the conversion or generation of high-pressure liquid or high-pressure gas, comprising a solid-state electrolyte, an anode, a cathode, characterized in in that the electrochemical cell comprises a frame according to claim 1, wherein the first opening in the anode frame comprises the anode and the second opening in the cathode frame comprises the cathode and wherein the solid-state electrolyte is arranged between the side opposite the first side of the frame of the anode frame and the side opposite the second side of the frame of the cathode frame, wherein one side of the solid-state electrolyte rests on the anode and the other side of the solid-state electrolyte rests on the step and the cathode.

13. The electrochemical cell according to claim 12, characterized in that the solid-state electrolyte has a thickness of less than 80 μm.

14. A pre-assembled module for the manufacture of a stack type device for the electrochemical conversion or generation of gases and liquids under pressure comprising an anode frame, a cathode frame, a BPP, an anode and a cathode,
wherein the anode frame comprises a first side of a frame with a planar first surface, a side opposite the first side of the frame of the anode frame and a first opening for receiving the anode,
wherein the first opening extends from the first side of the frame to the side opposite the first side of the frame of the anode frame, and wherein the first opening is framed by the anode frame, and wherein the anode frame comprises at least one connecting element for connection to the cathode frame, wherein the cathode frame comprises a second side of the frame with a planar second surface, a side opposite the second side of the frame of the cathode frame and a second opening for receiving the cathode,
wherein the second opening extends from the second side of the frame to the side opposite the second side of the frame of the cathode frame and is framed by the cathode frame, and wherein the cathode frame comprises at least one connecting element for receiving the pin, for connection to the anode frame,
wherein the BPP is arranged between the first side of the frame and the second side of the frame,
characterized in that the anode frame comprises a core and a coating made of sealing material and wherein the coating made of sealing material, and
wherein the BPP is connected to the anode to form a BPP/anode and the BPP/anode is inserted or pressed into the first opening and framed by the anode frame,
the cathode frame comprises a core and a coating made of sealing material, and wherein the cathode is inserted or pressed into the second opening and framed by the cathode frame, wherein the connecting element of the anode frame is connected to the connecting element of the cathode frame,
wherein the first opening is larger than the second opening and wherein the anode frame and the cathode frame are arranged such that the first side of the frame and the second side of the frame form a step at the transition from the anode frame to the cathode frame, and wherein the step forms a planar third surface as a support surface for the solid-state electrolyte wherein the BPP rests on one side on the anode and the anode frame and on the other side on the cathode, the cathode frame and the step.

15. a method of manufacturing a pre-assembled module for a stack type device for the electrochemical conversion or generation of gases and liquids under pressure, comprising the steps of
a) a core made of metal is produced for the anode frame, wherein the core comprises a first side of a frame with a planar first surface and a side opposite the first side of the frame of the anode frame, wherein the first side of the frame and the side opposite the first side of the frame of the anode frame comprise a first opening which extends from the first side of the frame to the side opposite the first side of the frame of the anode frame and which is framed by the anode frame, and wherein in the anode frame one or more channels type I for the supply and removal of liquid and gas are created, wherein the channels type I are not connected to the first opening in the anode frame, and wherein the anode frame comprises at least one connecting element for connection to the cathode frame,
b) all or part of the surface of the core made of metal for the anode frame produced according to a) is completely or partially coated with natural or synthetic rubber and subsequently vulcanized and thereby a coating made of rubber is created on the core made of metal as a sealing material, wherein in the coating made of rubber one or more channels type II are created on the surface of the first side, which are connected to one or more channels type I and which connect the channel(s) type I with the first opening and which, when the anode frame is installed in an electrochemical cell or a stack type device, are arranged in the direction of the BPP, and wherein no channels type II are created in the coating made of rubber on the side opposite the first side of the frame of the anode frame,
c) an anode is placed or pressed into the anode frame produced in accordance with a) and b),
d) a core made of metal is produced for the cathode frame, wherein the core comprises a second side of the frame with a planar second surface and a side opposite the second side of the frame of the cathode frame, wherein the second side and the side opposite the second side of the frame of the cathode frame comprise a second opening which extends from the second side of the frame to the opposite side of the cathode frame and which is framed by the cathode frame, and wherein in the cathode frame one or more channels type I for the supply and removal of liquid and gas are created, wherein the channels type I are not connected to the second opening in the cathode frame, and wherein the cathode frame comprises at least one connecting element for connection to the anode frame,
e) all or part of the surface of the core made of metal for the cathode frame produced according to d) is completely or partially coated with natural or synthetic rubber and subsequently vulcanized and thereby a coating made of rubber is created on the core made of metal as a sealing material, wherein in the coating made of rubber one or more channels type II channels are created on the surface of the second side of the frame, which are connected to one or more channels type I channels and which connect the channel(s) type I with the second opening and which, when the cathode frame is installed in an electrochemical cell or a stack type device, are arranged in the direction of the BPP, and wherein no channels type II are created in the coating made of rubber on the side opposite the second side of the cathode frame,
f) the cathode frame produced according to d) and e) is connected by means of the at least one connecting element of the cathode frame to the anode frame produced according to a) to c) by means of the at least one connecting element of the anode frame, wherein the BPP is arranged between the first side of the frame and the second side of the frame, and the cathode is inserted or pressed into the cathode frame.

16. A method of manufacturing a stack type device for operation under differential pressure for converting or generating high pressure liquid or gas comprising the steps of,
a) at least x pre-assembled modules according to claim 14 and at least x+1 solid-state electrolytes are stacked alternately on top of each other, wherein a stack of pre-assembled modules is produced, wherein in the stack of pre-assembled modules one pre-assembled module and one solid-state electrolyte are alternately stacked on top of each other, and wherein one solid-state electrolyte is arranged on the top side and the bottom side of the stack of pre-assembled modules and one solid-state electrolyte is arranged between two adjacent pre-assembled modules, and wherein
b) a half-cell anode and an anode frame are arranged parallel to an outer solid-state electrolyte on one side of the stack of pre-assembled modules and a half-cell cathode, and a cathode frame, are arranged parallel to an outer solid-state electrolyte on the other side of the stack of pre-assembled modules,
c) an end plate is arranged parallel to the half-cell anode and parallel to the half-cell cathode and the stack produced is then compressed between the two end plates to form a stack type device, where x is an integer and ≥2.

17. A stack type device for operation under differential pressure for the conversion or generation of high-pressure liquid or high-pressure gas, comprising x pre-assembled modules according to claim 14, x+1 solid-state electrolytes, a single anode or a half-cell anode, a single cathode or a half-cell cathode and two end plates, wherein the x pre-assembled modules and the x+1 solid-state electrolytes are stacked alternately one above the other to form a stack of pre-assembled modules, wherein one pre-assembled module and one solid-state electrolyte are stacked alternately one above the other in the stack of pre-assembled modules, and
wherein one solid-state electrolyte is arranged on the top side and one on the bottom side of the stack of pre-assembled modules and one solid-state electrolyte is arranged between two adjacent pre-assembled modules, and
a single anode (7′) or a half-cell anode is arranged parallel to an outer solid-state electrolyte on one side of the stack of pre-assembled modules and a single cathode (10′) or a half-cell cathode is arranged parallel to an outer solid-state electrolyte on the other side of the stack of pre-assembled modules,
wherein an end plate is arranged parallel to the individual anode or the half-cell anode and parallel to the individual cathode or the half-cell cathode, respectively, and the generated stack is compressed between the two end plates to form a stack type device,
where x is an integer and ≥2.

18. A stack type device for operation under differential pressure for generating high pressure liquid or high pressure gas comprising x+1 electrochemical cells according to claim 12, comprising x+1 solid-state electrolytes and x−1 BPPs, an upper end plate and a lower end plate,
wherein the x+1 electrochemical cells and the x−1 BPPs are stacked alternately one above the other, wherein in the stack one electrochemical cell and one BPP are alternatively stacked one above the other and wherein one BPP is arranged on the upper side and the lower side of the stack and one BPP is arranged between two adjacent electrochemical cells, and
wherein an upper end plate is arranged parallel to the BPP on the upper side of the stack and a lower end plate is arranged parallel to the BPP on the lower side of the stack, and the generated stack is compressed between the upper end plate and the lower end plate to form a stack type device,
where x is an integer and ≥2.

19. The stack type device according to claim 17, wherein each of the x+1 solid-state electrolytes has a thickness of less than 50 μm.

20. The stack type device according to claim 17 comprising two end plates, wherein the at least one end plate for providing space for liquid has at least two spaces for the distribution of liquid in the at least one end plate and wherein each of the at least two distribution covers has space for the distribution of liquid in the distribution cover and wherein at least one distribution cover for the introduction of liquid into the stack type device is connected to at least one connection for the introduction of liquid and a space for the distribution of liquid in the end plate, and wherein at least one further distributor cover for the discharge of liquid from the stack type device is connected to at least one connection for the discharge of liquid and a space for the distribution in the end plate.

21. A lid for a stack type device according to claim 17, wherein an end plate comprises at least one connection for the introduction of liquid into the stack type device, at least one connection for the discharge of liquid from the stack type device and at least two distributor covers, wherein the end plate has at least two spaces for the distribution of liquid in the end plate to provide space for liquid, and wherein each of the at least two distributor covers has space for liquid distribution in the distributor cover, and wherein at least one distributor cover is connected to at least one connection for the introduction of liquid into the stack type device for the introduction of liquid into the stack type device and a space for the distribution of liquid in the end plate, and wherein at least one further distributor cover is connected to at least one connection for the discharge of liquid for the discharge of liquid from the stack type device and a space for the distribution of liquid in the end plate.
